(19) United States
(12) Patent Application Publication
(10) Pub. No.: US 2015/0253851 A1
(43) Pub. Date: Sep. 10, 2015

(54) ELECTRONIC DEVICE AND METHOD FOR OUTPUTTING FEEDBACK

(71) Applicant: Samsung Electronics Co., Ltd., Suwon-si (KR)

(72) Inventors: Hae-Seok OH, Gumi-si (KR); Jeong-Yeon KIM, Daegu (KR); Dae-Beom PARK, Gumi-si (KR); Lae-Hyuk BANG, Gumi-si (KR); Gyu-Cheol CHOI, Gumi-si (KR); Chul-Hyung YANG, Gumi-si (KR); Tae-Hwan WI, Suwon-si (KR)

(21) Appl. No.: 14/584,478

(22) Filed: Dec. 29, 2014

(30) Foreign Application Priority Data
Mar. 6, 2014 (KR) 10-2014-0026603

(51) Int. Cl. G06F 3/01; G06F 3/0488; G06F 3/0354

(52) U.S. Cl. CPC G06F 3/016; G06F 3/03545; G06F 3/04883; G06F 2203/014

(57) ABSTRACT

An electronic device and method for outputting feedback corresponding to input handwriting is provided. The method for outputting feedback corresponding to a handwriting trajectory includes receiving input of the handwriting trajectory onto a screen, dividing the handwriting trajectory into axis-specific component vectors, generating a plurality of feedback signals corresponding to the respective component vectors, and outputting the feedback signals corresponding to the handwriting trajectory.

### CROSS-REFERENCE TO RELATED APPLICATION(S)

This application claims the benefit under 35 U.S.C. §119(a) of a Korean patent application filed on Mar. 6, 2014 in the Korean Intellectual Property Office and assigned Serial No. 10-2014-0026603, the entire disclosure of which is hereby incorporated by reference.

### TECHNICAL FIELD

The present disclosure relates to an electronic device and method for outputting feedback corresponding to input handwriting.

### BACKGROUND

Based on advances in technology, various services and additional functions provided in electronic devices have progressively improved. To further improve the effective value of the electronic devices and satisfy various demands of users, additional advanced applications which are executable in the electronic devices are continuously being developed.

Presently, hundreds of applications may be stored in electronic devices such as, for example, smart phones and tablet Personal Computers (PCs). Objects (i.e., shortcut icons) for executing the respective applications, or handwriting applications, such as a note application, a notepad, and a diary, for inputting handwriting through a finger or an input unit may also be displayed on screens of the electronic devices. Hence, the user may execute a desired application or generate handwriting contents in the electronic device by touching one of the shortcut icons displayed on the screen or inputting handwriting.

Once handwriting is input in an electronic device, a single sound mapped in advance is output when movement of an input unit or a finger on a screen is sensed. The single sound is output regardless of velocity, moving direction, and pressure of the handwriting, and likewise, the same vibration is output as feedback.

As discussed above, feedback output of the related art is provided in the form of sound or vibration to allow a user to recognize the action of handwriting. However, the same sound or vibration is output such that the user is not provided with adaptive feedback regarding how the handwriting is being input. As a result, the user may feel monotony from a simple one-dimensional user experience.

Therefore, a need exists for a scheme in which, upon generation of a touch input or handwriting input, feedback using at least one of sound and vibration based on at least one of a moving direction, a velocity, and a pressure of the input is generated and output, allowing the user to feel various concrete feedback and feel the sense of manipulation corresponding to manipulation of the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and method for outputting feedback corresponding to input handwriting.

In accordance with an aspect of the present disclosure, a method for outputting feedback corresponding to a handwriting trajectory is provided. The method includes receiving input of the handwriting trajectory onto a screen, dividing the handwriting trajectory into axis-specific component vectors, generating a plurality of feedback signals corresponding to the respective component vectors, and outputting the feedback signals corresponding to the handwriting trajectory.

According to an embodiment of the present disclosure, the generating of the plurality of feedback signals may include extracting a unit feedback signal corresponding to each coordinate axis from among at least one specified unit feedback signals.

According to an embodiment of the present disclosure, the outputting of the feedback signals may include separately outputting the feedback signals generated for each coordinate axis or combining the generated feedback signals and outputting the combination result.

According to an embodiment of the present disclosure, the feedback signals may be output after at least one of amplitudes and frequencies of the feedback signals are adjusted.

According to an embodiment of the present disclosure, the unit feedback signal corresponding to each coordinate axis may include a first unit feedback signal corresponding to a first coordinate axis and a second unit feedback signal corresponding to a second coordinate axis.

According to an embodiment of the present disclosure, the first unit feedback signal and the second unit feedback signal may include different signal patterns.

According to an embodiment of the present disclosure, each coordinate axis may include a first coordinate axis and a second coordinate axis, and the plurality of feedback signals may be changed in their amplitudes based on a component vector on the first coordinate axis and may be changed in their frequencies based on the second coordinate axis.

According to an embodiment of the present disclosure, the feedback signals may be generated based on a length of a component vector measured during a unit of time.

According to an embodiment of the present disclosure, the feedback signals may differ with at least one of a moving direction, a velocity, and a pressure of the handwriting trajectory.

According to an embodiment of the present disclosure, the generating of the feedback signals may include extracting at least one of a sound pattern and a vibration pattern corresponding to a vector component of each coordinate axis along a moving direction of a handwriting trajectory and summing the extracted patterns.

According to an embodiment of the present disclosure, the generated feedback signals may be output corresponding to the input of the handwriting trajectory on a real time basis.

According to an embodiment of the present disclosure, the feedback signals may be output proportionally to or inversely proportionally to at least one of the velocity and the pressure of the handwriting trajectory.

According to an embodiment of the present disclosure, the method may further include transmitting the feedback signals to another electronic device that is external to the electronic device to allow the other electronic device to output the feedback signals.

In accordance with another aspect of the present disclosure, an electronic device is provided. The electronic device includes a screen configured to receive an input of a handwriting trajectory, a controller configured to divide the handwriting trajectory into the handwriting trajectory into axis-specific component vectors and generate a plurality of feedback signals corresponding to the respective component vectors, a communication unit configured to transmit the feedback signals to another electronic device, and an output unit configured to output the feedback signals corresponding to the handwriting trajectory.

According to an embodiment of the present disclosure, the electronic device may further include a storage configured to store a unit feedback signal specified for each coordinate axis corresponding to at least one of a moving direction, a velocity, and a pressure of the handwriting trajectory, and the controller may be configured to extract the unit feedback signal for the handwriting trajectory.

According to an embodiment of the present disclosure, the controller may be configured to separately output the feedback signals generated for each coordinate axis or combine the generated feedback signals and output the combination result.

The feedback according to various embodiments of the present disclosure may include at least one of audible feedback, tactile feedback, and visual feedback.

In accordance with another aspect of the present disclosure, an input unit is provided. The input unit includes a short-range communication unit functionally connected with an electronic device to receive a feedback signal from the electronic device, a controller configured to control the feedback signal, and an output unit configured to output the feedback signal.

In accordance with another aspect of the present disclosure, a method for controlling a screen by using an electronic device is provided. The method includes obtaining an input from a user through the screen, determining at least one input attribute corresponding to the input based on at least one of a moving direction, a velocity, and a pressure of the input, and outputting a feedback signal determined based on the at least one input attribute through an output device functionally connected with the electronic device, in which, if the at least one input attribute is a first attribute, a first feedback signal is provided, and if the at least one input attribute is a second attribute, a second feedback signal is provided.

According to an embodiment of the present disclosure, the method may further include extracting a unit feedback signal corresponding to each coordinate axis from among at least one specified unit feedback signals.

According to an embodiment of the present disclosure, the at least one input attribute may include a first input attribute and a second input attribute, and the outputting of the determined feedback signal may include separately outputting feedback signals, respectively, corresponding to the first input attribute and the second input attribute, as a plurality of signals or combining the feedback signals and outputting one signal.

According to an embodiment of the present disclosure, the feedback signals may be output after at least one of amplitudes and frequencies of the feedback signals are adjusted based on the at least one input attributes.

According to an embodiment of the present disclosure, the unit feedback signal corresponding to each coordinate axis may include a first unit feedback signal corresponding to a first coordinate axis and a second unit feedback signal corresponding to a second coordinate axis.

According to an embodiment of the present disclosure, the first unit feedback signal and the second unit feedback signal may include different signal patterns.

According to an embodiment of the present disclosure, each coordinate axis may include a first coordinate axis and a second coordinate axis, and the feedback signals may be changed in their amplitudes based on a component vector on the first coordinate axis and may be changed in their frequencies based on the second coordinate axis.

According to an embodiment of the present disclosure, the amplitudes of the feedback signals may be output proportionally to or inversely proportionally to at least one of a velocity and a pressure of the input.

According to an embodiment of the present disclosure, the method may further include extracting at least one of a sound pattern and a vibration pattern corresponding to a vector component of each coordinate axis along a moving direction of the input and summing the extracted patterns.

According to an embodiment of the present disclosure, the method may further include transmitting the feedback signal to another electronic device that is external to the electronic device to allow the other electronic device to output the feedback signal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic device according to an embodiment of the present disclosure;

FIG. 2 is a diagram illustrating an input unit according to an embodiment of the present disclosure;

FIG. 3 is a flowchart illustrating a process of outputting feedback corresponding to an input handwriting trajectory according to an embodiment of the present disclosure;

FIG. 4 is a flowchart illustrating a process of outputting feedback corresponding to an input handwriting trajectory according to an embodiment of the present disclosure;

FIG. 5 is a flowchart illustrating a process of outputting feedback corresponding to an input handwriting trajectory according to an embodiment of the present disclosure;

FIG. 6 is a diagram illustrating a waveform of a pattern according to various embodiments of the present disclosure;

FIG. 7A is a diagram in which a moving direction of a handwriting trajectory is divided into component vectors per unit time according to an embodiment of the present disclosure;

FIG. 7B is a diagram in which a moving direction of a handwriting trajectory is divided into X-axis unit vectors according to an embodiment of the present disclosure;

FIG. 7C is a diagram in which a moving direction of a handwriting trajectory is divided into Y-axis unit vectors according to an embodiment of the present disclosure;

FIG. 8A is a diagram illustrating a waveform that is set for X-axis unit vectors according to an embodiment of the present disclosure;

FIG. 8B is a diagram illustrating a waveform that is set for Y-axis unit vectors according to an embodiment of the present disclosure;

FIG. 8C is a diagram illustrating a process of summing a waveform corresponding to X-axis unit vectors with a waveform corresponding to Y-axis unit vectors according to an embodiment of the present disclosure;

FIG. 8D is a diagram illustrating a result of summing a waveform corresponding to X-axis unit vectors with a waveform corresponding to Y-axis unit vectors according to an embodiment of the present disclosure;

FIG. 9 is a flowchart illustrating a process of outputting feedback corresponding to the velocity of handwriting that is input onto a screen according to an embodiment of the present disclosure;

FIG. 10 is a diagram illustrating a pattern that is output with respect to a velocity of handwriting that is input onto a screen according to an embodiment of the present disclosure;

FIG. 11 is a flowchart illustrating a process of outputting feedback corresponding to a pressure of handwriting that is input onto a screen according to an embodiment of the present disclosure;

FIG. 12 is a diagram illustrating patterns output corresponding to pressures of handwriting input onto a screen according to an embodiment of the present disclosure; and

FIG. 13 is a flowchart illustrating a process of transmitting feedback corresponding to a handwriting trajectory to another device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although ordinal numbers such as “first,” “second,” and so forth will be used to describe various components of the present disclosure, those components are not limited by the terms. The terms are used only for distinguishing one component from another component. For example, a first component may be referred to as a second component and likewise, a second component may also be referred to as a first component, without departing from the teaching of the inventive concept. The term “and/or” used herein includes any and all combinations of one or more of the associated listed items.

The terminology used herein is for the purpose of describing an embodiment only and is not intended to be limiting of an embodiment. As used herein, the singular forms are intended to include the plural forms as well, unless the context clearly indicates otherwise. It will be further understood that the terms “comprises” and/or “has” when used in this specification, specify the presence of a stated feature, number, step, operation, component, element, or a combination thereof but do not preclude the presence or addition of one or more other features, numbers, steps, operations, components, elements, or combinations thereof

The terms used herein, including technical and scientific terms, have the same meanings as terms that are generally understood by those skilled in the art, unless otherwise indicated the terms are differently defined. It should be understood that terms defined in a generally-used dictionary have meanings coinciding with those of terms in the related technology unless otherwise indicated. As long as the terms are not defined obviously, they are not ideally or excessively analyzed as formal meanings.

Hereinafter, operating principles of preferred embodiments of the present disclosure will be described in detail with reference to the attached drawings. In the following description, detailed descriptions of related known elements or functions that may unnecessarily make the gist of the present disclosure obscure will be omitted. The terms described later in the present specification are defined in consideration of functions in the present disclosure and may vary depending on the intention or usage of a user or an operator. Therefore, the terms should be defined based on the overall content of the present specification.

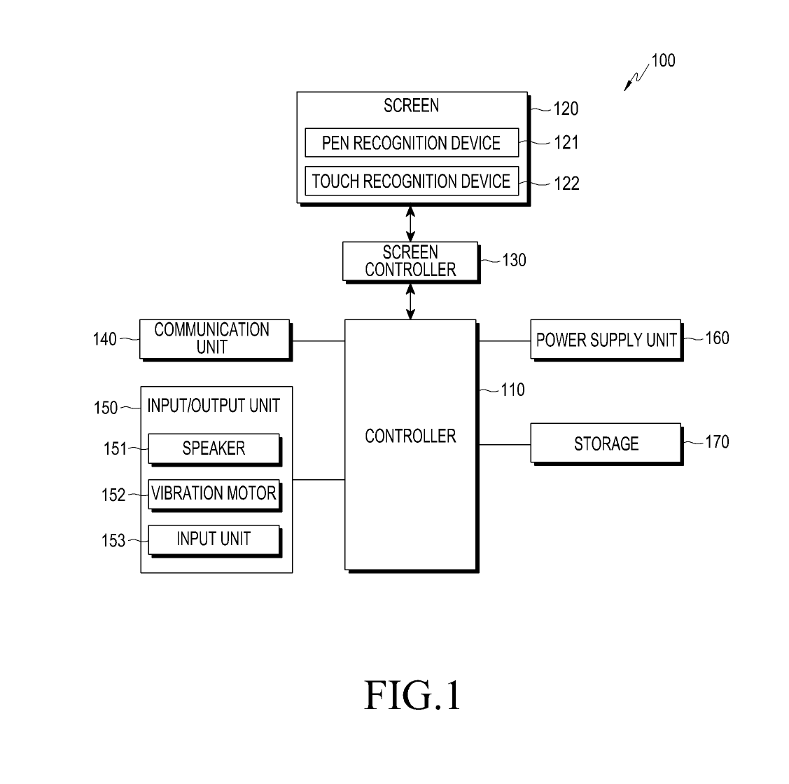

FIG. 1 is a diagram illustrating an electronic device according to an embodiment of the present disclosure.

Referring to FIG. 1, an electronic device 100 may be connected with an external device (not illustrated) by using at least one of a communication unit 140, an input/output unit 150, a connector (not illustrated), and an earphone connecting jack (not illustrated). The electronic device 100 may be implemented as a mobile terminal capable of transmitting and receiving data and performing voice and video communication, and may include at least one screen. The electronic device 100 may be implemented as a smartphone, a tablet Personal Computer (PC), and any device that is capable of communicating with a peripheral device or another terminal located in a remote place and is equipped with at least one screen. The external device may include various devices which are removable from the electronic device 100 and are connectible with the external device 100 in a wired manner, such as, for example, an earphone, an external speaker, a Universal Serial Bus (USB) memory, a charging device, a cradle/dock, a Digital Multimedia Broadcasting (DMB) antenna, a mobile payment-related device, a health management device (a blood pressure monitor or the like), a game console, a vehicle navigation device, and so forth. The external device may include a wirelessly connectible Bluetooth communication device, a Near Field Communication (NFC) device, a WiFi Direct communication device, and a wireless Access Point (AP). The electronic device 100 may be connected with another device, such as, for example, a cellular phone, a smart phone, a tablet PC, a desktop PC, a digitizer, an input device, a camera, a server, and the like in a wired or wireless manner.

Referring to FIG. 1, the electronic device 100 may include at least one screen 120 and at least one screen controller 130. The electronic device 100 may include at least one of the screen 120, the screen controller 130, the communication unit 140, the input/output unit 150, a power supply unit 160, and a storage 170.

The at least one screen 120 may provide a user interface corresponding to various services (for example, a call, document creation, drawing, data transmission, broadcasting, picture taking, character string inputting, and so forth) to users. Each screen may include at least one of a pen recognition device 121 that recognizes an input using at least one of an input unit and a finger and a touch recognition device 122 that recognizes a touch inputted using at least one of a finger and an input unit. The pen recognition device 121 and the touch recognition device 122 may also be respectively referred to as a pen recognition panel and a touch panel. Each screen transmits an analog signal corresponding to at least one touch inputted to the user interface to a corresponding screen controller. The electronic device 100 may include a plurality of screens, each of which may include a screen controller for receiving an analog signal corresponding to a touch or hovering. Each screen may be connected to each of a plurality of housings through hinge coupling or a plurality of screens may be connected to one housing without a hinge coupling. The electronic device 100 according to various embodiments of the present disclosure may include at least one screen and the following description will be made for one screen for convenience.

A controller 110 may include a Central Processing Unit (CPU), a Read Only Memory (ROM) in which a control program for controlling the electronic device 100 is stored, and a Random Access Memory (RAM) which memorizes a signal or data input from the electronic device 100 or is used as a memory region for a task performed in the portable terminal 100. The CPU may include a single core, a dual core, a triple core, or a quad core processor.

The controller 110 controls the electronic device 100 and controls at least one of the screen 120, the pen recognition device 121, the touch recognition device 122, the screen controller 130, the communication unit 140 the input/output unit 150, the power supply unit 160, and the storage 170.

The controller 110 displays a trajectory formed by various objects, an input character string, or input handwriting, determines whether hovering or a touch corresponding to an approach of various input units to any one object is recognized, identifies an object corresponding to a position at which hovering or a touch occurs, and recognizes a point on the screen 120 at which the hovering or the touch occurs. The controller 110 senses a height of an input unit from the electronic device 100 and a hovering input event based on the height, and the hovering input event may include at least one of pressing of a button formed in the input unit, tapping of the input unit, movement of the input unit at higher velocity than a threshold velocity, and a touch on the object.

The controller 110 communicates with a neighboring communication device or a remote communication device through at least one of a sub communication unit (not illustrated) and a WLAN unit (not illustrated) included in the communication unit 140, and controls reception of various data such as images, emoticons, pictures, and the like and communicates with the input unit over the Internet network. The communication may be performed using transmission and reception of a control signal.

The controller 110, according to various embodiments of the present disclosure, controls and outputs at least one of vibration and sound feedback of the electronic device 100 corresponding to a touch or hovering input on the screen 120 or an exterior of the electronic device 100. The controller 110 also controls and outputs at least one of visual feedback, audible feedback, and tactile feedback of the electronic device 100. The controller 110 outputs at least one of a preset-strength vibration and a sound corresponding to at least one input of a home button (not illustrated), a menu button (not illustrated), and a back button (not illustrated) provided on the screen 120 or the exterior of the electronic device 100. The controller 110 generates and outputs at least one of a new vibration and a new sound corresponding to an input command. The controller 110 outputs at least one of visual feedback, tactile feedback, and audible feedback corresponding to an input on the screen 120. The controller 110 analyzes a type or an attribute of a touch input or a hovering input from the user. An input type for a case where the user inputs handwriting by using a handwriting application displayed on the screen 120 to receive handwriting includes an initiating input allowing the user to know that handwriting has started, a releasing input allowing the user to know that handwriting has ended, and a moving input for substantial handwriting between the initiating handwriting and the releasing handwriting. The handwriting application for receiving handwriting according to various embodiments of the present disclosure may include applications for generating various documents, such as notepads, diaries, schedule records, and the like, which receive at least one of characters, words, character strings, and pictures inputted using at least one of an input unit and a finger and display the received input on the screen.

The controller 110, according to an embodiment of the present disclosure, outputs feedback based on an attribute of input handwriting. The controller 110 outputs feedback corresponding to an input handwriting trajectory. The controller 110 measures at least one of a moving direction, a velocity, and a pressure of the handwriting and outputs at least one of a sound and a vibration having a different strength corresponding to the measurement result in response to the input handwriting. The controller 110 generates and outputs at least one feedback based on an attribute of handwriting input onto the screen through the handwriting application. The attribute may include at least one of a moving direction, a velocity, and a pressure of the handwriting.

The controller 110, according to another embodiment of the present disclosure may display, on the screen 120, a recording state of sound in which handwriting is input corresponding to a coordinate-axis-(or axis)-specific unit vector and/or a coordinate-axis-(or axis)-specific component vector of a handwriting trajectory captured by a camera (not illustrated) provided in the electronic device 100. To this end, the controller 110 maps the unit vector or the element vector of the captured handwriting to a corresponding sound, and the mapping result is stored in the storage 170. The controller 110 recognizes the handwriting trajectory captured by the camera (not illustrated) and maps the handwriting trajectory to a coordinate system on a real-time or non-real-time basis. Once the handwriting trajectory is captured, the controller 110 displays the handwriting corresponding to the captured trajectory in time order through a handwriting-allowing application. The controller 110 analyzes at least one of a moving direction and a velocity of handwriting based on mapping of the trajectory of the captured handwriting to the coordinate system, generates, and stores or outputs feedback based on the analysis result. The controller 110 recognizes the handwriting captured using the camera (not illustrated) by using an Optical Character Recognition (OCR) function, and combines a moving direction or a stroke direction of the recognized handwriting with the sound recorded during the capturing. The controller 110 combines the moving direction or stroke direction of the recognized handwriting with the sound recorded during the capturing to perform sampling and generates visual feedback, tactile feedback, and audible feedback corresponding to unit vectors of the captured handwriting to store them in the storage 170 or output them through the input/output unit 150.

According to another embodiment of the present disclosure, if sampling corresponding to handwriting is completed, the controller 110 extracts handwriting for the completed sampling from the storage 170 and displays the extracted handwriting on the screen 120. The controller 110 recognizes the degree of inclination of the electronic device 100 and modulates at least one of visual feedback, audible feedback, and tactile feedback generated by input handwriting. The at least one modulated feedback may differ according to the degree of inclination of the electronic device 100. For example, if the electronic device 100 is inclined, the controller 110 may recognize the degree of inclination. The feedback output corresponding to the input handwriting may be different from feedback that is output when the electronic device 100 is not inclined even if the same handwriting is input. The controller 110 outputs at least one of visual feedback, audible feedback, and tactile feedback that differ according to a moving state of the electronic device 100.

The controller 110 recognizes weather by using a sensor provided on the exterior of the electronic device 100 to analyze weather, and modulates at least one of visual feedback, audible feedback, and tactile feedback generated by the input handwriting by applying the recognized weather to the at least one feedback. For example, output audible feedback for cloudy weather may have higher or lower frequency than for sunny weather.

The controller 110 adjusts and outputs output strength proportionally to or inversely proportionally to the measurement result.

If the handwriting application for receiving handwriting is used by two or more users together, the controller 110 identifies an input or handwriting input to the handwriting application by each user and analyzes a handwriting position, an input time, an input point, and a state in which the electronic device 100 is placed, to determine handwriting input by a main user and handwriting input by an auxiliary user. Even when two or more users input handwriting to the handwriting application at the same time, the controller 110 analyzes unit vectors or component vectors of handwriting input by each user and outputs at least one of visual feedback, audible feedback, and tactile feedback corresponding to the user-input handwriting based on the analysis result. The controller 110 analyzes an attribute of handwriting input by another user (for example, the auxiliary user) and outputs at least one of visual feedback, audible feedback, and tactile feedback corresponding to the analysis result. In this case, the feedback output corresponding to the handwriting input by another user may be output as vibration or sound having lower strength than that output corresponding to the handwriting input by the main user under control of the controller 110.

The controller 110 according to another embodiment of the present disclosure analyzes an attribute of handwriting input on the screen 120 and outputs feedback corresponding to the analysis result. The controller 110 senses handwriting input on the screen 120, generates feedback by using at least one of a moving direction, a velocity, and a pressure of the sensed handwriting, and outputs the generated feedback through the input/output unit 150. The controller 110 outputs feedback corresponding to a text input through a virtual keypad, and when handwriting is input during input of the text through the keypad, the handwriting application displays the handwriting input and outputs the corresponding feedback. The controller 110 recognizes voice input through a microphone (not illustrated), and displays a text corresponding to the recognition result through the handwriting application. The controller 110 outputs at least one of visual feedback, audible feedback, and tactile feedback according to display of the text corresponding to the recognition result. The input/output unit 150 may include at least one of a speaker 151, a vibration motor 152, and an input unit 153, and may also include the screen 120. The handwriting may be input by a touch or hovering on the screen 120. The controller 110 determines at least one of a strength and a length of at least one of a sound pattern and a vibration pattern corresponding to axis-specific component vectors per unit vector of an input handwriting trajectory, according to the sensing of the handwriting input on the screen 120, and sums patterns corresponding to extracted component vectors of coordinate axes. The controller 110 measures at least one of a velocity and a distance of the input handwriting. The controller 110 may form the screen 120 with two-dimensional (2D) coordinate axes (for example, an X axis and a Y axis) or three-dimensional (3D) coordinate axes (for example, an X axis, a Y axis, and a Z axis). The controller 110 may also form the screen 120 with an orthogonal coordinate system, a polar coordinate system, a cylindrical coordinate system, and a polygonal coordinate system. The controller 110 measures at least one of a velocity and a distance of handwriting input through the screen 120 formed with 2D or 3D coordinate axes for each unit vector or on a coordinate system, and adjusts at least one of a tone, a volume, a pitch, vibration, and a strength of the vibration of output feedback based on the measurement result. As such, the controller 110 may form the screen 120 with the 2D or 3D coordinate axes because the controller 110 can sense at least one of a touch input or a hovering input on the screen 120.

The controller 110, according to another embodiment of the present disclosure, maps handwriting input on the screen 120 to a coordinate space, divides the handwriting mapped to the coordinate space into axis-specific unit vectors, and divides a coordinate axis into component vectors corresponding to unit vectors of the other coordinate axes. At least one pattern corresponding to visual feedback, audible feedback, and tactile feedback corresponding to axis-specific unit vectors may be set in advance. The component vectors are multiplied to the axis-specific unit vectors, and at least one of visual feedback, audible feedback, and tactile feedback corresponding to the component vector may be generated by adjusting at least one of a size and a length of a pattern that is set in advance to the axis-specific unit vector. The pattern corresponding to the axis-specific component vector is generated by adjusting at least one of a size and a length of a pattern that is set in advance to the axis-specific unit vector. The controller 110 sums the pattern corresponding to the axis-specific unit vector with a pattern of a corresponding component vector. The controller 110 divides each coordinate axis (for example, an X axis, a Y axis, or a Z axis) into unit vectors having a threshold size or distance, and sets at least one of a sound pattern and a vibration pattern to be output through the input/output unit 150 for the axis-specific unit vector. At least one of the sound pattern and the vibration pattern, which are set for the axis-specific unit vector, may be different or the same. The patterns of the visual feedback, the tactile feedback, and the audible feedback, which are set for the axis-specific unit vector, may be different or the same. The controller 110 controls at least one of the speaker 151, the vibration motor 152, and the screen 120 to output at least one of the sound pattern and the vibration pattern corresponding to at least one of a moving direction, a velocity, and a pressure of handwriting per unit time, for input handwriting. The visual feedback displayed on the screen 120 may be set by the user or may be changed in environment settings of the electronic device 100. The sound pattern and the vibration pattern output through at least one of the speaker 151 and the vibration motor 152 may be output proportional to or inversely proportional to the measurement result. If the measurement result is greater than a threshold value, the controller 110 adjusts an output strength of at least one of the sound pattern and the vibration pattern to be greater than a strength corresponding to the threshold value and outputs the pattern. If the measurement result is less than the threshold value, the controller 110 adjusts an output strength of at least one of the sound pattern and the vibration pattern to be less than the strength corresponding to the threshold value and outputs the pattern. If the measurement result is greater than the threshold value, the controller 110 adjusts an output strength of at least one of visual feedback, audible feedback, and tactile feedback to be greater than the strength corresponding to the threshold value and outputs the feedback. If the measurement result is less than the threshold value, the controller 110 adjusts an output strength of at least one of visual feedback, audible feedback, and tactile feedback to be less than the strength corresponding to the threshold value and outputs the feedback.

The controller 110, according to another embodiment of the present disclosure, measures at least one of a moving direction, a velocity, and a pressure of input handwriting and outputs at least one of the sound pattern and the vibration pattern corresponding to the measurement result for the input handwriting on a real time basis.

The controller 110, according to another embodiment of the present disclosure, receives input of a handwriting trajectory on the screen 120, divides the input handwriting trajectory into axis-specific component vectors, generates a feedback signal corresponding to each coordinate axis, and outputs the generated feedback signal. The controller 110 extracts(or calls) a unit feedback signal corresponding to each coordinate axis from the storage 170. The unit feedback signal corresponding to each coordinate axis may differ with a coordinate axis. The coordinate axes includes first and second coordinate axes, and a unit feedback signal assigned to the first coordinate axis includes a first signal pattern and a unit feedback signal assigned to the second coordinate axis includes a second signal pattern that is different from the first signal pattern. The storage 170 stores a unit feedback signal for each coordinate axis, which differs with at least one of a moving direction, a velocity, and a pressure of the handwriting trajectory. The storage 170 may store not only the above-described feedback signals but also various sound and vibration patterns for outputting a feedback signal corresponding to a handwriting trajectory input onto the screen 120. The controller 110 controls the input/output unit 150 to separately output the feedback signal generated for each coordinate axis or combines and outputs the generated feedback signals. The controller 110 adjusts at least one of an amplitude and a frequency of the feedback signal and outputs the feedback signal. The feedback signal, according to various embodiments of the present disclosure, may be generated based on at least one of a change in the amplitude of the feedback signal according to a component vector of the first coordinate axis (or a first-axis component vector) and a change in the frequency of the feedback signal according to a component vector of the second coordinate axis (or a second-axis component vector). The controller 110 periodically measures the input handwriting trajectory and generates the feedback signal based on the length of the component vector measured periodically. The feedback signal may differ according to at least one of a moving direction, a velocity, and a pressure of the handwriting trajectory.

The controller 110, according to another embodiment of the present disclosure, senses a handwriting trajectory input onto the screen 120, generates feedback by summing patterns of respective coordinate axis corresponding to a moving direction of the sensed handwriting trajectory, and outputs the generated feedback corresponding to the input handwriting. The controller 110 may form the screen 120 with 2D coordinate axes (for example, an X axis and a Y axis) or 3D coordinate axes (for example, an X axis, a Y axis, and a Z axis), and divides each coordinate axis by a size or a unit. The controller 110 sets a sound and a vibration that can be output through the input/output unit 150 for an axis-specific unit vector divided by a size or a unit, and sums at least one of the sound and the vibration set for the axis-specific unit vector. At least one of the sound pattern and the vibration pattern set for the axis-specific unit vector may be different or the same. The controller 110 adjusts a sound pattern and a vibration pattern corresponding to an axis-specific component vector by using at least one of a sound pattern and a vibration pattern corresponding to an axis-specific unit vector, and sums the adjusted pattern corresponding to the axis-specific component vector. The controller 110 outputs the summed pattern by using at least one of an audible pattern, tactile feedback, and visual feedback through at least one of the screen 120 and the input/output unit 150. The audible feedback is feedback through which the user recognizes sound corresponding to input of handwriting, and may be output through the speaker 151. The tactile feedback is feedback through which the user recognizes vibration corresponding to input of handwriting, and may be output through the vibration motor 152. The visible feedback is feedback through which the user visually recognizes input of handwriting, and may be output through the screen 120. The visual feedback may be feedback generated by combining at least one of a moving direction, a velocity, and a pressure that are preset by the user or a moving direction, a velocity, and a pressure of handwriting for inputting preset visual information.

The controller 110, according to another embodiment of the present disclosure, senses a handwriting trajectory input onto the screen 120, measures at least one of a velocity and a pressure of the sensed handwriting, and extracts at least one of a sound pattern and a vibration pattern corresponding to at least one of the measured velocity and pressure to output the pattern corresponding to the input handwriting trajectory. The controller 110 measures the velocity through the handwriting trajectory input onto the screen 120 or measures the velocity by using a moving point per unit time on the screen 120. Typically, when handwriting is input, the trajectory is formed along the moving direction and the screen 120 displays the trajectory, and the controller 110 recognizes the handwriting trajectory along the moving direction of the handwriting. The controller 110 recognizes a point-in-time at which handwriting is input to each pixel, based on the trajectory, and measures a time between two points to determine the velocity. When handwriting is input on the screen 120, pressure is applied to the screen 120 and the pressure may differ according to the velocity and moving direction of handwriting. The controller 110 measures the strength of pressure applied to the screen 110 on a real time basis or on a periodic basis. The controller 110 measures at least one of a velocity and a pressure, and the at least one of the velocity and the pressure is measured per unit time or unit distance. The controller 110 outputs at least one of a sound pattern and a vibration pattern corresponding to the at least one of the velocity and the pressure measured per unit time or unit distance for the input handwriting trajectory. The controller 110 adjusts an output strength of the extracted at least one of the sound pattern and the vibration pattern to be in proportion to or in inverse proportion to the measurement result. If the measurement result is greater than a threshold value, the controller 110 outputs the at least one of the sound pattern and the vibration pattern with a higher strength than the strength corresponding to the threshold value. If the measurement result is less than the threshold value, the controller 110 outputs the at least one of the sound pattern and the vibration pattern with a lower strength than the strength corresponding to the threshold value.

The controller 110, according to another embodiment of the present disclosure, receives a handwriting trajectory on the screen 120, divides the handwriting trajectory into axis-specific component vectors, generates a plurality of feedback signals corresponding to the respective component vectors, and outputs the feedback signals corresponding to the handwriting trajectory. The controller 110 extracts a unit feedback signal corresponding to each coordinate axis among at least one specified unit feedback signals. The controller 110 separately outputs the feedback signal generated for each coordinate axis or combines the feedback signals and outputs the combination result. The feedback signal may be output after adjustment of at least one of its amplitude and frequency. The unit feedback signals corresponding to the respective coordinate axes may include a first unit feedback signal corresponding to a first coordinate axis and a second unit feedback signal corresponding to a second coordinate axis. The first unit feedback signal and the second unit feedback signal may include different signal patterns. The coordinate axes include the first coordinate axis and the second coordinate axis, and the plurality of feedback signals may be changed in their amplitudes according to the first-axis component vector. The controller 110 changes a frequency of the feedback signal according to the second coordinate axis. The feedback signal may be generated based on a length of a component vector measured periodically. The feedback signal may differ according to at least one of a moving direction, a velocity, and a pressure of the handwriting trajectory. The controller 110 extracts at least one of a sound pattern and a vibration pattern corresponding to the axis-specific component vector according to the input moving direction, and sums the extracted patterns. The generated feedback signal may be output corresponding to input of the handwriting trajectory on a real time basis. The feedback signal may be output proportional to or inversely proportional to at least one of the velocity and the pressure of the handwriting trajectory. The controller 110 may transmit the feedback signal to another electronic device which is an external device with respect to the electronic device 100 such that the external electronic device may output the feedback signal.

The controller 110, according to another embodiment of the present disclosure, obtains input from the user through the screen 120, determines at least one input attribute corresponding to the input based on at least one of a moving direction, a velocity, and a pressure of the input, and outputs the feedback signal determined based on the at least one input attribute through an output device functionally connected with the electronic device 100. If the at least one input attribute is a first attribute, the controller 110 provides a first feedback signal; if the at least one input attribute is a second attribute, the controller 110 provides a second feedback signal. The at least one input attributes may include the first input attribute and the second input attribute. The controller 110 separately outputs feedback signal corresponding to the first input attribute and the second input attribute, respectively, as a plurality of signals or combines the feedback signals and outputs one signal. The controller 110 extracts at least one of the sound pattern and the vibration pattern corresponding to an axis-specific component vector according to the moving direction of the input, and sums the extracted patterns.

The screen 120 may receive at least one touch or hovering through a user's body (for example, a finger including a thumb) or a touchable input unit (for example, a stylus pen or an electronic pen). The screen 120 outputs visual feedback corresponding to the input. The screen 120 may include at least one of the pen recognition device 121 and the touch recognition device 122, in which once an input is made onto the screen 120 through the stylus pen or the electronic pen, the pen recognition device 121 recognizes the input and the touch recognition device 122 recognizes a touch. The pen recognition device 122 recognizes a distance between a pen and the screen 120 through a magnetic field, ultrasonic waves, optical information, or surface acoustic waves, and the touch recognition device 122 senses a touch position by using electric charges moved by the touch. The touch recognition device 122 is capable of sensing any touch that may generate static electricity and a touch input through an input unit or a finger. When the user inputs at least one touch, the screen 120 generates handwriting by using an input unit or a finger or receives movement or a command made by one or more continuous touches or hovering input through a virtual keypad. Even when displaying a text input through the virtual keypad, the screen 120 may also receive and display a handwriting input. The screen 120 may also display the text corresponding to voice input through a microphone (not shown). The screen 120 transmits an analog signal corresponding to a continuous movement of a touch generating handwriting to the screen controller 130.

In various embodiments of the present disclosure, a touch may also include a non-contact touch (for example, a user's body or a touchable input unit may be detected without a direct contact with the screen 120) as well as a direct contact between the screen 120 and the user's body or the touchable input unit. A distance or interval from the screen 120 within which the user's body or the input means may be detected may be changed according to the capability or structure of the electronic device 100. In particular, to separately detect a direct touch event based on a contact with the user's body or the input unit and an indirect touch event (i.e., a hovering event), the screen 120 may be configured to output different values for values (for example, an analog voltage value or current value) detected in the direct touch event and the hovering event. Furthermore, the screen 120 may also output different values (for example, a current value) for distances between the screen 120 and a space where the hovering event occurs.

The touch recognition device 122 or the pen recognition device 121 may be implemented as, for example, a resistive type, a capacitive type, an infrared type, an acoustic wave type, or a combination thereof.

The screen 120 may include at least two touch panels capable of sensing a touch, an approach of the user's body or the input unit to sequentially or simultaneously receive inputs or commands generated by the user's body or the input unit. The at least two touch panels provide different output values to the screen controller. Thus, the screen controller differently recognizes the values input from the at least two touch screen panels to identify whether the input from the screen 120 is the input generated by the user's body or by the input unit. The screen 120 may display at least one objects or input character strings.

More specifically, the screen 120 may include a touch panel for sensing an input made by a finger or an input unit through a change of an induced electromotive force and a touch panel for sensing contact on the screen 120 by the finger or the input unit are sequentially stacked from top to bottom by being closely adhered to one another or partially spaced apart from one another. The screen 120 may include multiple pixels and displays an image through these pixels or handwriting input by the input unit or the finger. For the screen 120, a Liquid Crystal Display (LCD), an Organic Light Emitting Diode (OLED), or an LED may be used.

The screen 120 may include a plurality of sensors that recognize a position on the surface of the screen 120 at which the finger or the input unit touches or the finger or the input unit is placed within a threshold distance from the surface of the screen 120. Each of the plurality of sensors may have a coil structure, and on a sensor layer formed of the plurality of sensors, the respective sensors may have preset patterns and form a plurality of electrode lines. With this structure, if a touch or hovering input occurs on the screen 120 through the finger or the input unit, a waveform-changed sensing signal is generated by a capacitance between the sensor layer and the input unit, and the screen 120 transmits the generated sensing signal to the controller 110. A threshold distance between the input unit and the pen recognition device 121 may be recognized through a strength of a magnetic field formed by a coil.

The screen controller 130 converts an analog signal received by a character string input on the screen 120 into a digital signal (for example, an X-axis coordinate, a Y-axis coordinate and/or a Z-axis coordinate) and transmits the digital signal to the controller 110. The controller 110 controls the screen 120 by using the digital signal received from the screen controller 130. For example, the controller 110 may control a shortcut icon (not illustrated) displayed on the screen 120 to be selected or executed in response to a touch event or a hovering event. The screen controller 130 may be included in the controller 110.

The screen controller 130, by detecting a value (for example, an electric-current value) output through the screen 120, recognizes a hovering interval or distance as well as a user input position and converts the recognized distance into a digital signal (for example, a Z coordinate), which it then sends to the controller 110.

The communication unit 140 may include a mobile communication unit (not illustrated), a sub communication unit (not illustrated), a Wireless Local Area Network (WLAN) unit (not illustrated), and a short-range communication unit (not illustrated). The mobile communication unit may facilitate the connection between the electronic device 100 and an external device through mobile communication by using one or more antennas (not illustrated) under control of the controller 110. The mobile communication unit transmits/receives a wireless signal for a voice call, a video call, a text message (Short Messaging Service (SMS)), and/or a multimedia message (Multi Media Service (MMS)) with a cellular phone (not illustrated), a smart phone (not illustrated), a tablet PC, or another device (not illustrated) which has a phone number input into the electronic device 100. The sub communication unit may include at least one of the WLAN unit (not illustrated) and the short-range communication unit (not illustrated). Alternatively, the sub communication unit may include either the WLAN unit or the short-range communication unit, or both.

The sub communication unit transmits a control signal to and receives a control signal from an input unit. The control signal transmitted and received between the electronic device 100 and the input unit may include at least one of a field for supplying power to the input unit, a field for sensing a touch or hovering between the input unit and the screen 120, a field for sensing pressing or inputting of a button provided in the input unit, a field indicating an identifier of the input unit, and a field indicating coordinates (for example, an X-axis coordinate, a Y-axis coordinate and/or a Z-axis coordinate) at which the input unit is located. The communication unit 140 transmits a signal corresponding to at least one of the tactile feedback and the audible feedback generated by the controller 110 to the input unit 153. The electronic device 100 transmits the feedback signal to another electronic device such that the external electronic device outputs the feedback signal. The communication unit 140 transmits the feedback signal to the other electronic device. The input unit transmits a feedback signal corresponding to the control signal received from the electronic device 100 to the electronic device 100. The WLAN unit may be connected to the Internet in a place where a wireless AP (not illustrated) is installed, under control of the controller 110. The WLAN unit supports the wireless LAN standard IEEE802.11x of the Institute of Electrical and Electronics Engineers (IEEE). The short-range communication unit may wirelessly perform short-range communication between the electronic device 100 and an image forming device (not illustrated) under control of the controller 110. The short-range communication may include Bluetooth, InfraRed Data Association (IrDA), WiFi-Direct communication, NFC communication, or the like.

The electronic device 100 may include at least one of the mobile communication unit, the WLAN unit, and the short-range communication unit, depending on its capability. The electronic device 100 may also include a combination of the mobile communication unit, the WLAN unit, and the short-range communication unit, depending on its capability. In various embodiments of the present disclosure, at least one of or a combination of the mobile communication unit, the WLAN unit, and the short-range communication unit may be referred to as a transmission/reception unit, and this feature does not limit the scope of the present disclosure.

The input/output unit 150 may include at least one of the speaker 151, the vibration motor 152, and the input unit 153. The input/output unit 150 may include at least one of buttons, a camera, a microphone, a connector, a keypad, an earphone connecting jack, and the like. The input/output module is not limited to the above examples, and a cursor control such as, for example, a mouse, a track ball, a joy stick, or a cursor direction key may be provided to control movement of a cursor on the screen 120. The input/output unit 150 outputs sound or vibration corresponding to a command that is input from a user. The input/output unit 150

The input/output unit 150 outputs a sound or a vibration corresponding to a command input from the user. The input/output unit 150 may include at least one of the speaker 151, the vibration motor 152, and the input unit 153, and may also include the screen 120. In various embodiments of the present disclosure, the input/output unit 120 may be referred to as an input unit or an output unit. The input/output unit 120 may output at least one feedback signal generated by the controller 110 in correspondence to a handwriting trajectory of the input unit. The input unit is functionally connected with the electronic device 100 and may include a short-range communication unit for receiving a feedback signal from the electronic device 100, a controller for controlling the feedback signal, and an output unit for outputting the feedback signal.

The speaker 151 outputs sound corresponding to various signals (for example, a wireless signal, a broadcast signal, a digital audio file, a digital video file, a captured picture, and the like) of the communication unit 140 and sound corresponding to a control signal provided to the input unit through Bluetooth® under control of the controller 110. The sound corresponding to the control signal includes sound corresponding to at least one command input to the electronic device 100 by the input unit 153 or the finger (not shown) or sound corresponding to handwriting input on a handwriting-allowing application. The volume of the sound may be controlled based on the strength of vibration of a vibration element of the input unit 153 or may be output simultaneously with or a time (for example, 10 ms) before/after activation of the vibration element through the speaker 151 and/or the speaker (not shown) included in the input unit 153. The outputting of the sound may be terminated simultaneously with or a time (for example, 10 ms) before/after activation of the vibration element. The speaker 151 outputs sound (for example, button manipulation sound corresponding to a phone call or a ring back tone) corresponding to a function executed by the electronic device 100, and one or more of the speaker 151 may be formed in areas of a housing of the electronic device 100.

The vibration motor 152 converts an electric signal into mechanical vibration under control of the controller 110. For example, in the electronic device 100, in a vibration mode, if a voice call or a video call from another device (not illustrated) is received, the vibration motor 152 operates. One or more of the vibration motor 152 may be disposed in the housing of the electronic device 100. Upon input of a command for executing at least one function provided in the electronic device 100, a user's touch action using the input unit 153 or the finger, a continuous movement of a touch, or handwriting on the screen 120, the vibration motor 152 operates with the same strength of vibration corresponding to an axis-specific unit vector of the input handwriting or with different strengths of vibration according to an input time period of the command or touch. The vibration motor 152 may also output vibration of different strengths according to a state in which the electronic device 100 is placed, or according to at least one of the velocity and pressure of handwriting input on the screen 120.

The input unit 153 is capable of providing a command or an input to the electronic device 100 in a direct contact state or a non-direct-contact state, such as hovering, on the screen 120. The input unit 153 may include at least one of a finger, an electronic pen, a digital type pen, a pen equipped with no integrated circuit, a pen equipped with an integrated circuit, a pen equipped with an integrated circuit and a memory, a pen capable of performing short-range communication, a joystick, and a stylus pen, which is capable of providing a command or an input to the electronic device 100 in a direct contact state or a non-direct-contact state, such as hovering, on the screen 120.

The power supply unit 160 supplies power to one or more batteries disposed in the housing of the electronic device 100 under control of the controller 110. The one or more batteries supply power to the electronic device 100. The power supply unit 160 may also supply power input from an external power source (not illustrated) through the wired cable connected with the connector (not illustrated) to the electronic device 100. The power supply unit 160 may also supply power, which is wirelessly input from the external power source (not illustrated) using a wireless charging technique, to the electronic device 100.

The storage 170 stores a signal or data that is input/output according to operations of the communication unit 140, the input/output unit 150, the screen 120, and a sensor unit (not shown) under control of the controller 110. The storage 170 stores a control program and applications for control of the electronic device 100 and/or the controller 110. The storage 170 stores data for outputting vibration of a certain strength corresponding to an input inputted to the electronic device 100 and adjusting the strength of vibration to a certain strength according to a time period in which the command is input. The storage 170 stores a pattern corresponding to at least one of visual feedback, audible feedback, and tactile feedback corresponding to a unit vector and/or an axis-specific component vector corresponding to a handwriting trajectory input onto the screen 120 and attribute information of the at least one pattern, such as size, time, and interval of the pattern. The storage 170 may also store at least one pattern for adjusting at least one of vibration and sound according to a pattern corresponding to at least one of a moving direction, a velocity, and a pressure of handwriting input to the electronic device 100. The at least one pattern may include various patterns having different sizes and vibration intervals corresponding to at least one of a moving direction, a velocity, and a pressure of handwriting input to the electronic device 100.

The storage 170 may include a non-volatile memory, a volatile memory, a Hard Disk Drive (HDD), or a Solid State Drive (SSD).

The storage unit 170 may include at least one of a character, a word, and a character string input to the screen 120, and may also store various data such as a text, an image, an emoticon, an icon, and so forth received over an Internet network. The storage 170 may also store applications of various functions such as navigation, video communication, games, an alarm application based on time, images for providing a Graphic User Interface (GUI) related to the applications, user information, documents, databases or data related to a method for processing touch inputs, background images (e.g., a menu screen, a standby screen, and so forth), operation programs necessary for driving the electronic device 100, and images captured by the camera (not illustrated). The storage 170 may be a machine, such as, for example, a non-transitory computer-readable medium. The term “machine-readable medium” includes a medium for providing data to the machine to allow the machine to execute a particular function. The machine-readable medium may be a storage medium. The storage 170 may include non-volatile media or volatile media. Such a medium needs to be of a tangible type so that commands delivered to the medium can be detected by a physical tool which reads the commands with the machine.

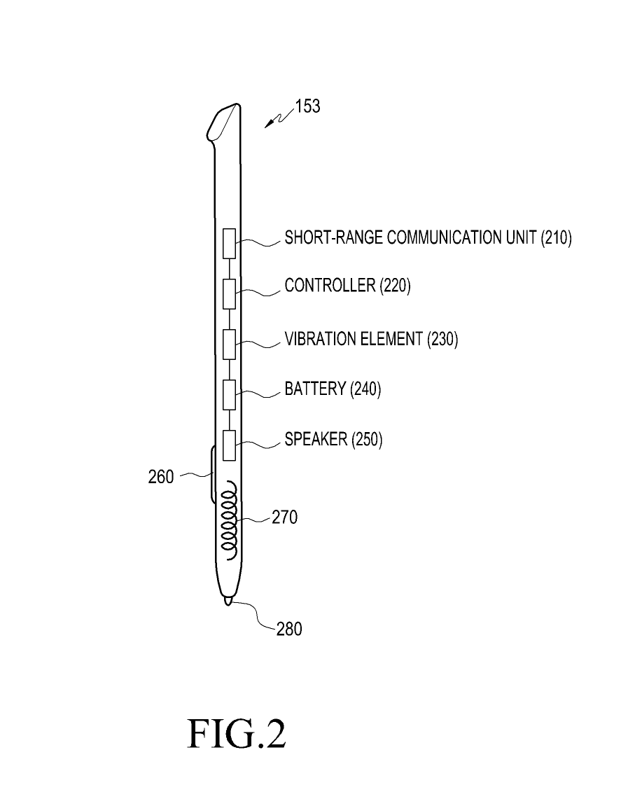

FIG. 2 is a diagram illustrating an input unit according to an embodiment of the present disclosure.

Referring to FIG. 2, the input unit 153 (for example, an EMR pen) may include at least one of a penholder, a pen point 280 disposed at the end of the penholder, a coil 270 disposed inside the penholder adjacent to the pen point 280, a button 260, a vibration element 230, a controller 220 for analyzing a control signal received from the electronic device 100, controlling vibration strength and interval of the vibration element 230, controlling short-range communication, and sensing the pressure of handwriting, a short-range communication unit 210 for performing short-range communication with the electronic device 100, and a battery 240 for supplying power necessary for the input unit 153. The input unit 153 may include an RC circuit for performing communication with the electronic device 100, and the RC circuit may be included in the input unit 153 or in the controller 220. The input unit 153 may also include a speaker 250 for outputting sound corresponding to vibration interval and/or vibration strength of the input unit 153. The speaker 250 may output sound simultaneously with or a time (for example, 10 ms) before/after the sound output from the speaker 151 included in the electronic device 100.

The input unit 153 structured in this way may support an electromagnetic induction scheme. If an electromagnetic field is formed in the coil 270 disposed at a particular position relative to the pen recognition device 121, the pen recognition device 121 detects a position of the electromagnetic field to recognize a position of the input unit.

More specifically, the speaker 250 outputs a sound corresponding to various signals (for example, a wireless signal, a broadcast signal, a digital audio file, or a digital moving image file) of the communication unit 140 provided in the electronic device 100 under control of the controller 220. The speaker 250 outputs a sound (for example, a button manipulation sound corresponding to a phone call or a ring back tone) corresponding to a function executed by the electronic device 100, and one or more of the speaker 250 may be formed in a predetermined position or positions of a housing of the input unit 153.

The controller 220 analyzes at least one control signal received from the electronic device 100 through the short-range communication unit 210 and controls the interval and strength of vibration of the vibration element 230 provided in the input unit 153 according to the analyzed control signals. The control signal may include pattern information corresponding to visual feedback, audible feedback, and tactile feedback provided in the electronic device 100.

The controller 220 senses pressing of the button 260 and transmits a control signal for changing an attribute of a pattern corresponding to at least one of visual feedback, audible feedback, and tactile feedback to the electronic device 100. The electronic device 100 receives the control signal and a haptic effect of a pattern corresponding to feedback may also be provided in the input unit 153. If a touch is generated by a finger (including a thumb, an index finger, or the like), the electronic device 100 may provide the haptic effect. If a touch is generated by the input unit 153, a control signal corresponding to the touch may be transmitted from the electronic device 100 to the input unit 153. The controller 220 transmits a feedback signal or input unit state information (for example, a remaining battery capacity, a communication state, and identification information) corresponding to the received control signal to the electronic device 100. The control signal is a signal transmitted and received between the electronic device 100 and the input unit 153, and may be periodically transmitted and received for a time or to a point in time at which a touch or hovering is terminated. The control signal may be transmitted to the input unit 153 if at least one of a moving direction, a velocity, and a pressure of handwriting input to the screen 120 is changed. The battery 240 that supplies power to operate the controller 220 may be charged using electric current induced from the electronic device 100.

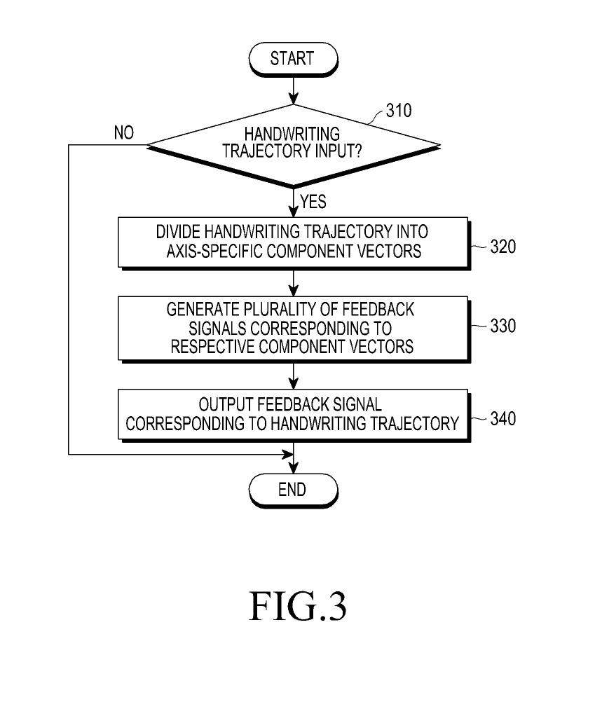

FIG. 3 is a flowchart illustrating a process of outputting feedback corresponding to an input handwriting trajectory according to an embodiment of the present disclosure.

Referring to FIG. 3, a description will now be made of a process of outputting feedback corresponding to an input handwriting trajectory according to an embodiment of the present disclosure.

The controller 110 senses a handwriting trajectory input onto the screen 120 in operation 310, and divides the input handwriting trajectory into axis-specific component vectors in operation 320. The controller 110 may sense the input handwriting trajectory on a unit time basis. The controller 110 may divide the input handwriting trajectory into axis-specific component vectors based on a length or a distance of the handwriting trajectory that is input for each unit time. A feedback signal may be allocated in advance for each coordinate axis. The controller 110 may control at least one of an amplitude and a frequency of the feedback signal that is assigned in advance based on the length or distance of the axis-specific component vector.

The controller 110 generates a plurality of feedback signals corresponding to respective component vectors in operation 330. The controller 110 may generate the plurality of feedback signals corresponding to respective axis-specific component vectors. The coordinate axis or the axis may include the first coordinate axis and the second coordinate axis, and for the plurality of feedback signals, the amplitude of the feedback signal may be changed based on a component vector. The controller 110 may change a frequency of the feedback signal based on the second coordinate axis. The controller 110 may extract (or call) a unit feedback signal corresponding to each coordinate axis from among at least one specified unit feedback signals. The unit feedback signal corresponding to each coordinate axis may include a first unit feedback signal corresponding to the first coordinate axis and a second unit feedback signal corresponding to the second coordinate axis. The first unit feedback signal and the second unit feedback signal may have different signal patterns. The controller 110 may control the input/output unit 150 to separately output at least one feedback signal generated for respective coordinate axes or combine the at least one feedback signal generated for the respective coordinate axes. The controller 110 may adjust at least one of the amplitude and the frequency of the feedback signal generated for each coordinate axis to generate a feedback signal. The controller 110 may sum patterns that are set for respective axis-specific unit vectors or that are adjusted from the respective axis-specific component vectors along the moving direction of handwriting input to the screen 120 to generate at least one of sound and vibration for a new pattern. Once the moving direction of handwriting is sensed, the controller 110 sums patterns corresponding to coordinate values in a threshold distance along the moving direction (for example, an X-axis coordinate value, a Y-axis coordinate value, or a Z-axis coordinate value). The controller 110 controls at least one of an amplitude and a frequency of a feedback signal that is preset for each coordinate axis based on a moving distance of a handwriting trajectory. The controller 110 may generate a feedback signal through such a control. The controller 110 may separately output or sum and output patterns that are preset for coordinate axes. The controller 110 extracts at least one of a sound pattern and a vibration pattern corresponding to each axis-specific vector component along the moving direction of the input and sums the extracted patterns.

The controller 110 outputs the generated feedback signal in operation 340. The controller 110 may output the feedback signal corresponding to the handwriting trajectory. The controller 110 may output the feedback signal generated corresponding to the input handwriting trajectory. The controller 110 may generate and output the feedback signal on a real time basis with respect to the input handwriting trajectory. The feedback signal may include at least one of vibration and sound. The controller 110 transmits the feedback signal to another electronic device that is an external device of the electronic device 100, such that the external electronic device outputs the feedback signal. The external electronic device may be an electronic device that is functionally connected with the electronic device according to various embodiments of the present disclosure. The external electronic device receives the feedback signal transmitted from the electronic device and outputs feedback corresponding to the received feedback signal. The external electronic device may include an input unit that may be mounted on the electronic device. The external electronic device may be an electronic device capable of communicating with the electronic device.

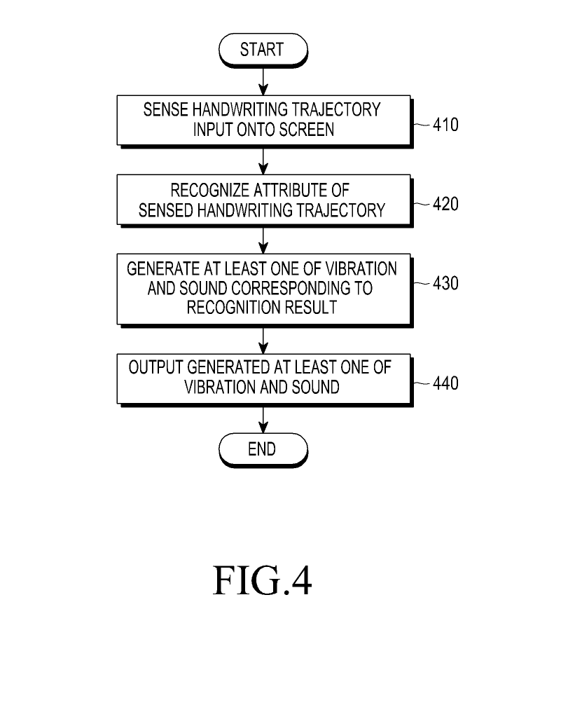

FIG. 4 is a flowchart illustrating a process of outputting feedback corresponding to an input handwriting trajectory according to another embodiment of the present disclosure.

Referring to FIG. 4, a description will be made of a process of outputting feedback corresponding to an input handwriting trajectory according to an embodiment of the present disclosure.

The controller 110 senses a handwriting trajectory input onto the screen 120 in operation 410. The controller 110 may sense the handwriting trajectory input on the screen 120 by using an input unit for each unit vector or unit time. The controller 110 may sense input handwriting or a handwriting trajectory by using at least one of a touch and hovering on the screen 120. The handwriting may include various forms of handwriting expressed by an input unit or a finger's gesture, such as a character or a picture. The controller 110 may also sense at least one input inputted on a home button (not illustrated), a menu button (not illustrated), and a back button (not illustrated) provided on the exterior of the electronic device 100 as well as an input inputted on the screen 120.

The controller 110 recognizes an attribute of the sensed handwriting in operation 420. The controller 110 measures at least one of a moving direction, a velocity, and a pressure of handwriting sensed on the screen 120. The controller 110 may measure at least one of a moving direction, a velocity, and a pressure of handwriting input to a handwriting-allowing application displayed on the screen 120. The controller 110 may adjust at least one of a sound pattern and a vibration pattern corresponding to each axis-specific component vector by using at least one of a sound pattern and a vibration pattern corresponding to each axis-specific unit vector based on the moving direction, velocity, and/or pressure of the handwriting sensed on the screen 120. The controller 110 may sum the adjusted patterns corresponding to the axis-specific component vectors. For each axis-specific unit vector or component vector, at least one of a sound pattern and a vibration pattern may be preset. Each axis-specific component vector may be generated using at least one of the preset sound pattern and vibration pattern. For example, the sound pattern and the vibration pattern corresponding to the axis-specific component vector are generated based on a rate of each axis-specific component vector in the sound pattern and the vibration pattern corresponding to each axis-specific unit vector or component vector. At least one of a length and an amplitude of a pattern set for a unit vector on a coordinate axis may be the same as or different from those of a pattern set for a unit vector on another coordinate axis.

The controller 110 may generate at least one of a sound pattern and a vibration pattern based on at least one of a velocity and a pressure of handwriting. The controller 110 may extract a pattern having a different length and amplitude according to the velocity of the handwriting or extract a pattern having a different length and amplitude according to the pressure of the handwriting. The controller 110 measures at least one of a velocity and a pressure of the handwriting sensed on the screen 120, and extracts at least one of a sound pattern and a vibration pattern corresponding to the measurement result. The output strength of the extracted at least one of the sound pattern and the vibration pattern may be in proportion to or in inverse proportion to the measurement result. If the measurement result is greater than a threshold value, the output strength of at least one of the sound pattern and the vibration pattern is greater than a strength corresponding to the threshold value. If the measurement result is less than the threshold value the output strength of at least one of the sound pattern and the vibration pattern is less than the strength corresponding to the threshold value.

The controller 110 generates at least one of a vibration and a sound based on the recognition result in operation 430. The controller 110 may generate at least one of a sound and a vibration for a new pattern by summing patterns that are set for axis-specific unit vectors or component vectors or that are adjusted from axis-specific component vectors along the moving direction of the handwriting input on the screen 120. Once the moving direction of the handwriting is sensed, the controller 110 may sum patterns corresponding to coordinate values in a distance along the moving direction (for example, an X-axis coordinate value, a Y-axis coordinate value, or a Z-axis coordinate value). The controller 110 adjusts a pattern that is preset for each axis-specific unit vector to the pattern corresponding to each coordinate value, and sums the adjusted sound and vibration patterns corresponding to the axis-specific component vectors. The controller 110 maps the handwriting input to the screen 120 to a coordinate space, divides the handwriting mapped to the coordinate space into unit vectors, and sums patterns corresponding to axis-specific component vectors of the unit vectors to generate a new pattern.

In operation 440, the controller 110 outputs the at least one of the vibration and the sound generated in operation 430. The controller 110 may control the input/output unit 150 to correspond to at least one of the generated vibration pattern and sound pattern. The controller 110 controls the input/output unit 150 to output at least one of the vibration pattern and the sound pattern generated in operation 430. The controller 110 outputs a sound pattern, which is generated by summing sound patterns corresponding to axis-specific component vectors or unit vectors along the moving direction of the handwriting sensed on the screen 120, through the speaker 151 or outputs a vibration pattern corresponding to each axis-specific component vector or unit vector along the moving direction of the handwriting sensed on the screen 120 through the vibration motor 152. The controller 110 may simultaneously output the sound pattern and the vibration pattern through the speaker 151 and the vibration motor 152. The controller 110 may output a sound or a vibration corresponding to input handwriting. The controller 110 may output a sound and a vibration together corresponding to input handwriting. The controller 110 samples at least one of the output sound pattern and vibration pattern and stores the sampled pattern in the storage 170. The sampled at least one of the sound pattern and the vibration pattern may be used for handwriting input in the future.

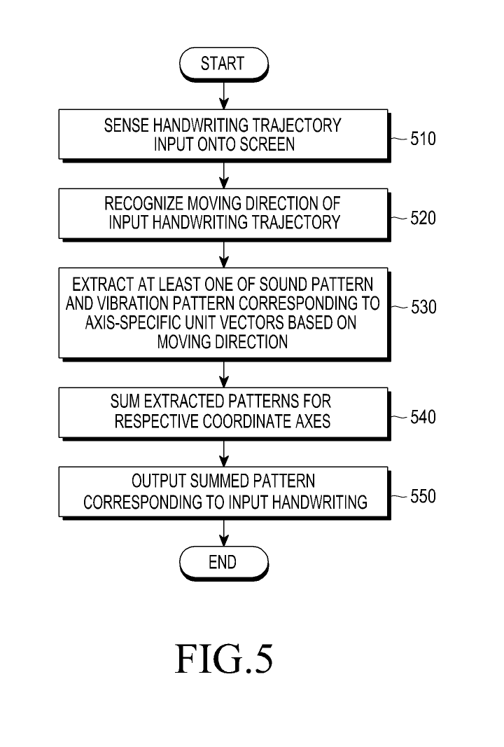

FIG. 5 is a flowchart illustrating a process of outputting feedback corresponding to an input handwriting trajectory on the screen 120 according to another embodiment of the present disclosure.

Referring to FIG. 5, a description will be made of a process of outputting feedback corresponding to handwriting input on a screen according to an embodiment of the present disclosure.

The controller 110 senses a handwriting trajectory that is input on the screen 120 in operation 510. The controller 110 may sense a handwriting trajectory that is input using at least one of a touch and a hovering on the screen 120. The handwriting includes various forms of handwriting expressed by an input unit or a finger's gesture, such as a character or a picture. The controller 110 may sense at least one input inputted on a home button (not illustrated), a menu button (not illustrated), a back button (not illustrated), or the like provided on the exterior of the electronic device 100 as well as an input inputted on the screen 120.

The controller 110 recognizes a moving direction of the input handwriting trajectory in operation 520, and extracts at least one of a sound pattern and a vibration pattern corresponding to axis-specific unit vectors along the moving direction in operation 530. The controller 110 may form the screen 120 with 2D coordinate axes (for example, an X axis and a Y axis) or with 3D coordinate axes (for example, an X axis, a Y axis, and a Z axis), and divides each coordinate axis by a size or a unit. At least one of the sound pattern and the vibration pattern that may be output through the input/output unit 150 may be set for the unit vectors of each coordinate axis divided by the size or the unit, and at least one of a sound and a vibration corresponding to each axis-specific component vector may be generated using at least one of the sound pattern and the vibration pattern set for the axis-specific unit vectors. At least one of a sound and a vibration corresponding to the generated component vectors may be generated by adjusting a strength and a period of at least one of the sound pattern and the vibration pattern that are set for the unit vectors. At least one of the sound pattern and the vibration pattern that are set for axis-specific unit vectors may be the same or different. The controller 110 may sum at least one of the sound pattern and the vibration pattern corresponding to the axis-specific component vectors. For example, the controller 110 may sum sound patterns corresponding to axis-specific component vectors or vibration patterns corresponding to axis-specific component vectors. The controller 110 may map handwriting input onto the screen 120 to a coordinate space, divide a unit vector of handwriting mapped to the coordinate space into axis-specific component vectors, and sum patterns corresponding to the axis-specific component vectors.

The controller 110 sums the patterns of the respective axes in operation 540 and outputs the summed patterns corresponding to the input handwriting in operation 550. The controller 110 may sum patterns corresponding to the axis-specific component vectors. The controller 110 may divide the handwriting mapped to the coordinate space into unit vectors and sum patterns corresponding to axis-specific component vectors of each unit vector. The pattern corresponding to the component vector may be summed using a pattern that is preset for each axis-specific unit vector. The preset pattern may be different or the same according to each axis-specific unit vector. The controller 110 outputs the summed pattern by using at least one of audible feedback, tactile feedback, and visual feedback through at least one of the screen 120 and the input/output unit 150. The audible feedback is feedback through which the user recognizes a sound corresponding to an input of handwriting, and may be output through the speaker 151. The tactile feedback is feedback through which the user recognizes a vibration corresponding to an input of handwriting, and may be output through the vibration motor 152. The visible feedback is feedback through which the user visually recognizes an input of handwriting, and may be output through the screen 120. The visual feedback may be feedback generated by combining at least one of a moving direction, a velocity, and a pressure that are preset by the user or a moving direction, a velocity, and a pressure of handwriting for inputting preset visual information.

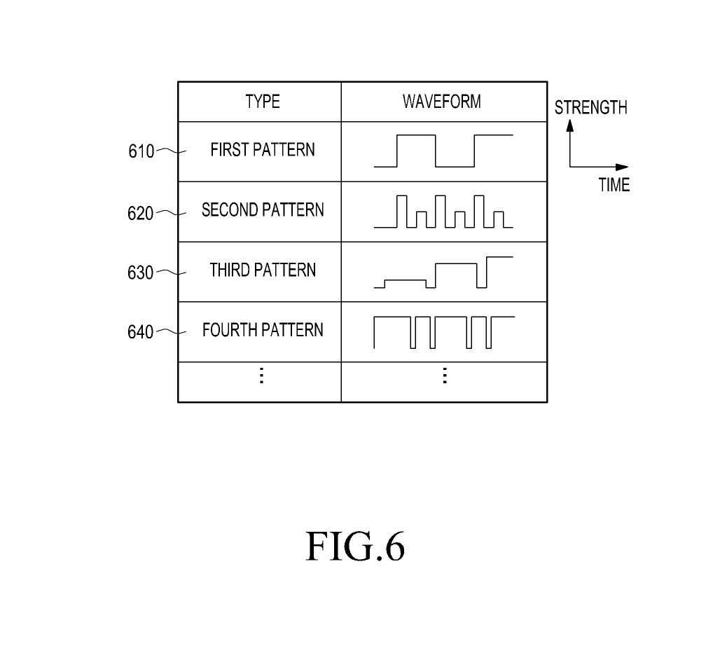

FIG. 6 is a diagram illustrating waveforms corresponding to patterns according to various embodiments of the present disclosure.

Referring to FIG. 6, a waveform of each pattern may be a periodic or aperiodic waveform. At least one of a strength, a time, and a period of a waveform of each of patterns 610, 620, 630, and 640 may be designated or changed by a user, and a vibration strength may differ according to a pattern. In FIG. 6, a horizontal axis (for example, an X axis) indicates a period with respect to a time and a vertical axis (for example, a Y axis) indicates a vibration strength of a pattern. Although only four patterns are shown in FIG. 6, they are merely examples, and the present disclosure may include four or more waveforms without being limited to four waveforms and the waveforms may be the same as or different from each other. More specifically, the present disclosure includes various feedback waveforms that may be experienced in real life in addition to the above-described waveforms. Each pattern may be set to any one of a moving direction, a velocity, and a pressure of handwriting or may be set for each coordinate axis of the moving direction or each axis-specific unit vector or component vector. Each pattern may be periodically executed or may be executed at least once.

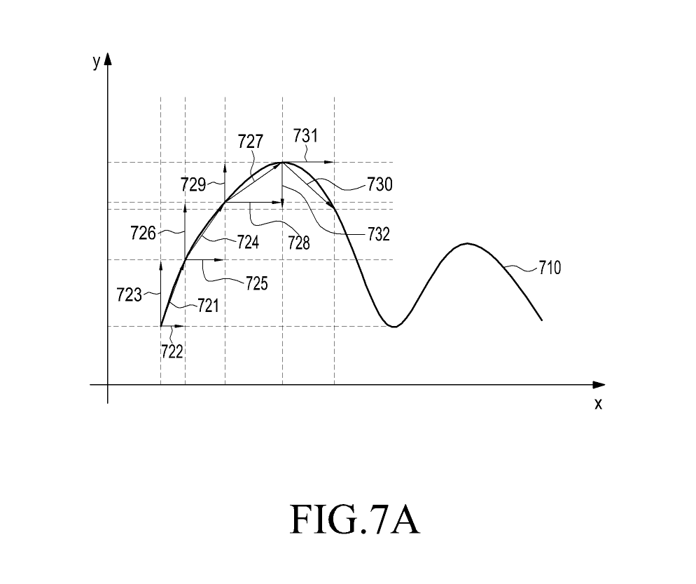

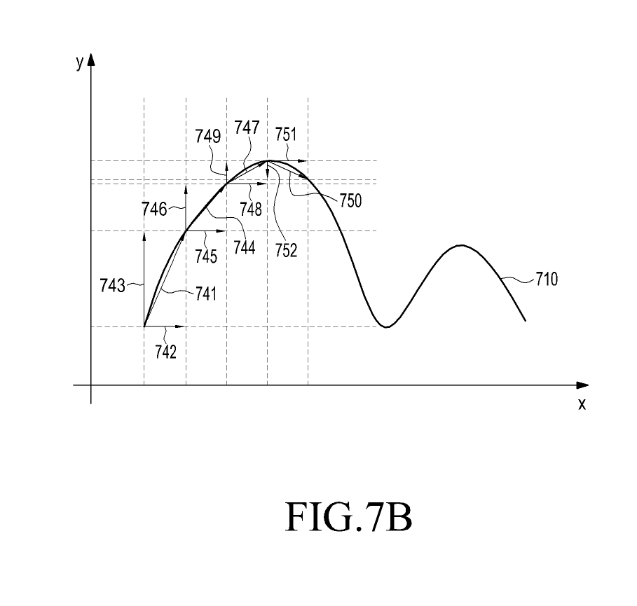

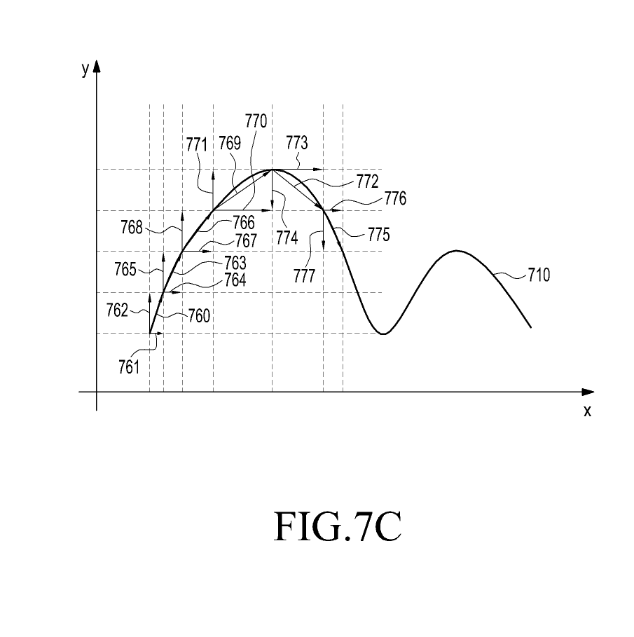

FIGS. 7A to 7C are diagrams illustrating an axis-specific component vector in a moving direction of a handwriting trajectory according to an embodiment of the present disclosure.

More specifically, FIG. 7A is a diagram in which a moving direction of a handwriting trajectory is divided into unit vectors per unit time according to an embodiment of the present disclosure, FIG. 7B is a diagram in which a moving direction of a handwriting trajectory is divided into X-axis unit vectors according to an embodiment of the present disclosure, and FIG. 7C is a diagram in which a moving direction of a handwriting trajectory is divided into Y-axis unit vectors according to an embodiment of the present disclosure.

Although FIGS. 7A to 7C illustrate a 2D moving direction along an X axis and a Y axis, this is merely an example and the present disclosure may also be applied to a 3D moving direction along an X axis, a Y axis, and a Z axis.

Referring to FIG. 7A, a trajectory 710 of handwriting input onto the screen 120 is illustrated and a moving direction of handwriting, that is, a handwriting trajectory according to an embodiment of the present disclosure may be divided into unit vectors or component vectors per unit time, and the size of each axis-specific component vector corresponding to each unit vector may be recognized and may differ from component vector to component vector. The size of each axis-specific component vector per unit time may differ from component vector to component vector. The trajectory 710 of the handwriting may be divided into unit vectors 721, 724, 727, and 730 per unit time. X-axis component vectors 722, 725, 728, and 731 and Y-axis component vectors 723, 726, 729, and 732 corresponding to the respective unit vectors 721, 724, 727, and 730 may be recognized. In the trajectory 710 of the handwriting, the first unit vector 721 has a first X-axis component vector 722 and a first Y-axis component vector 723, the second unit vector 724 has a second X-axis component vector 725 and a second Y-axis component vector 726, the third unit vector 727 has a third X-axis component vector 728 and a third Y-axis component vector 729, and the fourth unit vector 730 has a fourth X-axis component vector 731 and a fourth Y-axis component vector 732.

While a handwriting trajectory is divided into unit vectors per unit time and each unit vector is divided into an X-axis component vector and a Y-axis component vector along the moving direction of the handwriting in FIG. 7A, this is merely an example. In an alternative embodiment, the present disclosure divides an X axis into the unit vectors of the same size along the moving direction of the handwriting and then divides a Y axis into component vectors corresponding to each X-axis unit vector (refer to FIG. 7B). The present disclosure may also divide a Y axis into unit vectors of the same size along the moving direction of the handwriting and divide an X axis into component vectors corresponding to each X-axis unit vector (see FIG. 7C). The moving direction of the handwriting according to the present disclosure may be divided into unit times and may be divided into X-axis component vectors and Y-axis component vectors through points divided by the unit times. As such, when a trajectory is divided, according to a reference coordinate axis (for example, an X axis or a Y axis) or unit time, a vector value of the non-reference coordinate axis may be adjusted. A pattern set for a unit vector of the trajectory 710 may be any one of a plurality of patterns illustrated in FIG. 6. The controller 110 may output at least one of a sound and a vibration using a pattern having a different size for a different axis-specific component vector. The controller 110 sums a size of a pattern corresponding to an X-axis component vector and a size of a pattern corresponding to a Y-axis component vector of the trajectory 710 and outputs at least one of a sound and a vibration by using a pattern corresponding to the summed size. The controller 110 may separately output a feedback signal that is preset for each axis-specific component vector. The controller 110 may also sum feedback signals that are preset for axis-specific component vectors and output the summation result.

Referring to FIG. 7B, the moving direction or trajectory 710 of the handwriting input to the screen 120 is illustrated, and the trajectory 710 may be divided into X-axis unit vectors, such that the sizes of X-axis unit vectors and Y-axis component vectors of the trajectory 710 may be recognized.

Referring to FIG. 7B, the trajectory 710 may be divided into X-axis unit vectors. A first section 741 from a start point of the moving direction of the handwriting is divided into an X-axis unit vector 742 and a Y-axis component vector 743, a second section 744 starting from the first section 741 is divided into an X-axis unit vector 745 and a Y-axis component vector 746, a third section 747 starting from the second section 744 is divided into an X-axis unit vector 748 and a Y-axis component vector 749, and a fourth section 750 starting from the third section 747 is divided into an X-axis unit vector 751 and a Y-axis component vector 752. Although the X axis is divided into unit vectors of the same size and the Y axis is divided into component vectors corresponding to the respective unit vectors along the moving direction of the handwriting in FIG. 7B, this is merely an example, and the present disclosure may divide the Y axis into the unit vectors of the same size and divide the X axis into component vectors corresponding to the respective Y-axis unit vectors.

According to an embodiment of the present disclosure, the moving direction may be divided by unit time and may be divided into an X-axis component vector and a Y-axis component vector at each point divided by unit time. As such, when the trajectory is divided into unit vectors, according to a reference coordinate axis (for example, the X axis or the Y axis) or unit time, a vector value of the non-reference coordinate axis may be adjusted. Referring to FIG. 7B, when the X axis is a reference axis, the unit vectors 742, 745, 748, and 751 may have patterns having the same size and Y-axis component vectors 743 746, 749, and 752 corresponding to the X-axis unit vectors 742, 745, 748, and 751 may have patterns of different sizes according to the moving direction or size of the trajectory 710 per X-axis unit vector. The X-axis unit vector or a Y-axis unit vector for a reference axis, the Y axis, may be set to one of the plurality of patterns illustrated in FIG. 6. The sizes of the Y-axis component vectors 743, 746, 749, and 752 corresponding to the X-axis unit vectors 742, 745, 748, and 751 are adjusted based on the sizes of the X-axis unit vectors 742, 745, 748, and 751. For example, a pattern of the first Y-axis component vector 743 may have a larger size than that of the X-axis unit vector 742. A pattern of the second Y-axis component vector 746 may have the same size as that of the X-axis unit vector 745. Patterns of the third and fourth Y-axis component vectors 749 and 752 may have smaller sizes than those of the X-axis unit vectors 748 and 751. In this way, the controller 110 sums a pattern corresponding to each axis-specific unit vector and a pattern corresponding to each axis-specific component vector and outputs at least one of sound and vibration using the summation result. The controller 110 sums a size of a pattern corresponding to an X-axis unit time with a size of a pattern corresponding to a Y-axis component vector and outputs at least one of a sound and a vibration corresponding to the summation result.

Referring to FIG. 7C, the moving direction (i.e., the trajectory 710) of handwriting input on the screen 120 is illustrated and the trajectory 710 according to an embodiment of the present disclosure, may be divided into Y-axis unit vectors, such that the sizes of Y-axis unit vectors and X-axis component vectors of the trajectory 710 may be recognized.

Referring to FIG. 7C, the trajectory 710 may be divided into Y-axis unit vectors. A first section 760 starting from a start point of the trajectory 710 is divided into an X-axis component vector 761 and a Y-axis unit vector 762, a second section 763 starting from the first section 760 is divided into an X-axis component vector 764 and a Y-axis unit vector 765, a third section 766 starting from the second section 763 is divided into an X-axis component vector 767 and a Y-axis unit vector 768, a fourth section 769 starting from the third section 766 is divided into an X-axis component vector 770 and a Y-axis unit vector 771, a fifth section 772 starting from the fourth section 769 is divided into an X-axis component vector 773 and a Y-axis unit vector 774, and a sixth section 775 starting from the fifth section 772 is divided into an X-axis component vector 776 and a Y-axis unit vector 777. Although the Y-axis is divided into unit vectors of the same size and the X axis is divided into component vectors corresponding to the Y-axis unit vectors along the moving direction of the handwriting in FIG. 7C, this is merely an example, and the present disclosure may divide the X axis into the same unit vectors and divide the Y axis into component vectors corresponding to the X-axis unit vectors along the moving direction of the handwriting. In addition, an embodiment of the present disclosure may divide the moving direction of the handwriting by unit time and divide the moving direction into an X-axis component vector and a Y-axis component vector at each point divided by unit time. As such, when the trajectory 710 is divided into unit vectors, according to a reference coordinate axis (for example, an X axis or a Y axis) or unit time, a vector value of the non-reference coordinate axis may be adjusted.

Referring to FIG. 7C, when the Y axis is a reference axis, the unit vectors 762, 765, 768, 771, 774, and 777 may have patterns having the same sizes, and the X-axis component vectors 761, 764, 767, 770, 773, and 776 corresponding to the Y-axis unit vectors 762, 765, 768, 771, 774, and 777 may have patterns having different sizes according to the moving direction or size of the trajectory 710 per Y-axis unit vector. The Y-axis unit vector or an X-axis unit vector for the reference axis, the X axis, may have one of the plurality of patterns illustrated in FIG. 6. The sizes of the X-axis component vectors 761, 764, 764, 767, 770, 773, and 776 corresponding to the Y-axis unit vectors 762, 765, 768, 771, 774, and 777 are adjusted based on the sizes of the Y-axis unit vectors. For example, patterns of the first and second X-axis component vectors 761 and 764 may have a smaller size than that of the Y-axis unit vectors 762 and 765, respectively. Patterns of the third X-axis component vector 767 may have the same size as that of the Y-axis unit vector 768. And, a pattern of the fourth X-axis component vector 770 may have a larger size than that of the Y-axis unit vector 771. As such, the controller 110 sums a pattern corresponding to each axis-specific unit vector and a pattern corresponding to each axis-specific component vector and outputs at least one of a sound and a vibration using the summation result. The controller 110 sums a size of a pattern corresponding to a Y-axis unit time with a size of a pattern corresponding to an X-axis component vector and outputs at least one of sound and vibration corresponding to the summation result.

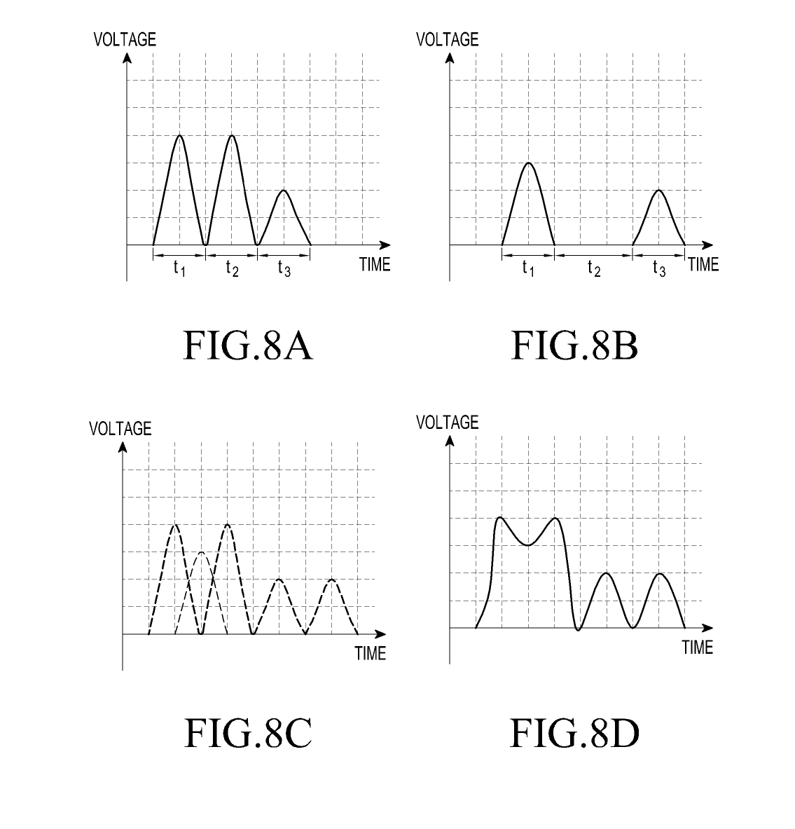

FIGS. 8A to 8D are diagrams showing summation of patterns according to various embodiments of the present disclosure.

More specifically, FIG. 8A is a diagram illustrating a waveform that is set for X-axis unit vectors according to an embodiment of the present disclosure, FIG. 8B is a diagram illustrating a waveform that is set for Y-axis unit vectors according to an embodiment of the present disclosure, FIG. 8C is a diagram illustrating a process of summing the waveform that is set for the X-axis unit vectors and the waveform that is set for the Y-axis unit vectors according to an embodiment of the present disclosure, and FIG. 8D is a diagram illustrating a result of summing the waveform that is set for the X-axis unit vectors and the waveform that is set for the Y-axis unit vectors according to an embodiment of the present disclosure.

Referring to FIG. 8A, which shows the waveform that is set for X-axis unit vectors according to various embodiments of the present disclosure, a first unit time t1 and a second unit time t2 on the X axis have equal voltages and a third unit time t3 has a lower voltage than the first unit time t1 and the second unit time t2. Each unit time and voltage may be adjusted variably. As is shown, a waveform set for an X-axis unit vector has a sound or vibration pattern output through the voltages corresponding to the first unit time t1 through the third unit time t3.

Referring to FIG. 8B, which shows the waveform set for Y-axis unit vectors according to various embodiments of the present disclosure, a first unit time t1, a second unit time t2, and a third unit time t3 on the Y axis have different voltages. The voltage of the first unit time t1 is highest, and the voltage of the second unit time t2 is zero. The voltage of the third unit time t3 is lower than that of the first unit time t1 and is higher than that of the second unit time t2. Each unit time and voltage may be adjusted variably. As is shown, the waveform set for the Y-axis unit vectors has a sound pattern or a vibration pattern output through the voltages corresponding to the first unit time t1 through the third unit time t3.

Referring to FIG. 8C, which shows a process of summing the waveform corresponding to the X-axis unit vectors according to various embodiments of the present disclosure with the waveform corresponding to the Y-axis unit vectors according to various embodiments of the present disclosure, the waveform set for the X-axis unit vectors shown in FIG. 8A are summed with the waveform set for the Y-axis unit vectors shown in FIG. 8B. Likewise, the present disclosure may sum a waveform set for X-axis unit vectors with a waveform corresponding to Y-axis component vectors, and sum a waveform set for Y-axis unit vectors with a waveform corresponding to X-axis component vectors. Component vectors on a coordinate axis may be adjusted by unit vectors on another coordinate axis.

FIG. 8D shows a result of summing the waveforms corresponding to the X-axis unit vectors according to various embodiments of the present disclosure with the waveform corresponding to the Y-axis unit vectors according to various embodiments of the present disclosure. In FIG. 8D, through the summing process shown in FIG. 8C, a waveform of a new pattern is generated. However, FIGS. 8A through 8D merely show examples, and various embodiments of the present disclosure may use different strengths of sound and vibration and different output times according to a waveform set for unit vectors of each coordinate axis.

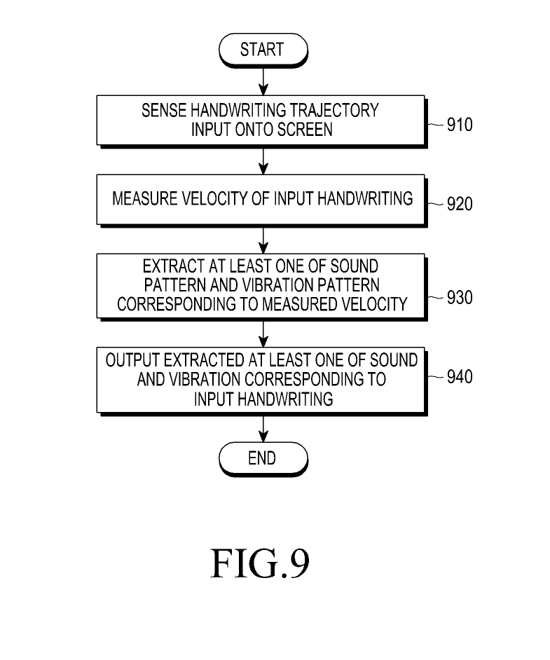

FIG. 9 is a flowchart illustrating a process of outputting feedback corresponding to the velocity of handwriting input onto the screen 120 according to another embodiment of the present disclosure.

In FIG. 9, a description will be made of a process of outputting feedback corresponding to the velocity of handwriting input onto a screen according to an embodiment of the present disclosure.

Referring to FIG. 9, the controller 110 senses a handwriting trajectory input onto the screen 120 in operation 910. The controller 110 may sense handwriting input using a touch on the screen 120. The handwriting includes various forms of handwriting expressed using an input unit or a gesture of a finger, such as a character or a picture. The controller 110 may sense at least one input inputted on a home button (not illustrated), a menu button (not illustrated), a back button (not illustrated), and the like provided on the exterior of the electronic device 100 as well as an input inputted on the screen 120.

The controller 110 measures the velocity of the handwriting input onto the screen 120 in operation 920, and extracts at least one of a sound pattern and a vibration pattern corresponding to the measured velocity in operation 930. The controller 110 measures the velocity of the handwriting per unit time. The controller 110 senses the handwriting trajectory input onto the screen 120, measures the velocity of the sensed handwriting, and extracts at least one of the sound pattern and the vibration pattern corresponding to the measured velocity. The controller 110 senses the handwriting trajectory input onto the screen 120 and extracts a pattern corresponding to each coordinate axis along the moving direction of the sensed handwriting. The controller 110 extracts at least one of a sound pattern and a vibration pattern corresponding to the velocity of the handwriting or extracts a pattern corresponding to a unit vector and/or a component vector of each coordinate axis along the moving direction of the input handwriting. The controller 110 extracts at least one of the sound pattern and the vibration pattern corresponding to the pressure of the handwriting, and sums the extracted patterns. The pattern corresponding to the pressure and/or velocity of the handwriting and the pattern corresponding to the moving direction of the handwriting may also be summed. The present disclosure extracts a pattern corresponding to each of the moving direction, the velocity, and the pressure of the input handwriting. Typically, handwriting may be performed with all of the moving direction, the velocity, and the pressure at the same time, and even when the moving direction, the velocity, and the pressure are used at the same time, the present disclosure extracts and sums patterns corresponding to the respective attributes, such that even when the moving direction, the velocity, and the pressure are simultaneously used, at least one of sound and vibration may be output with a pattern corresponding to the summation result.

The controller 110 outputs the extracted at least one of the sound pattern and the vibration pattern corresponding to the input handwriting in operation 940. The controller 110 may output at least one of a sound pattern and a vibration pattern corresponding to a velocity measured per unit time for the input handwriting. The controller 110 may sum a pattern corresponding to a velocity measured per unit time with a pattern corresponding to a velocity of handwriting per unit time, and output a pattern corresponding to the summation result. The output strength of the extracted at least one of the sound pattern and the vibration pattern may be in proportion to or in inverse proportion to the measurement result. For example, as the measured velocity of the handwriting increases, the strength of the output pattern may increase or decrease. If the measurement result is greater than a threshold value, the output strength of the at least one of the sound pattern and the vibration pattern may be greater than a strength corresponding to the threshold value. If the measurement result is less than the threshold value, the output strength of at least one of the sound pattern and the vibration pattern may be less than the strength corresponding to the threshold value. The controller 110 may output the extracted at least one of the sound pattern and the vibration pattern corresponding to the velocity of the handwriting, output the extracted pattern on each coordinate axis along the moving direction of the input handwriting, or output a new pattern corresponding to the summation result of the pattern corresponding to the velocity of the handwriting with the pattern corresponding to the moving direction of the handwriting.

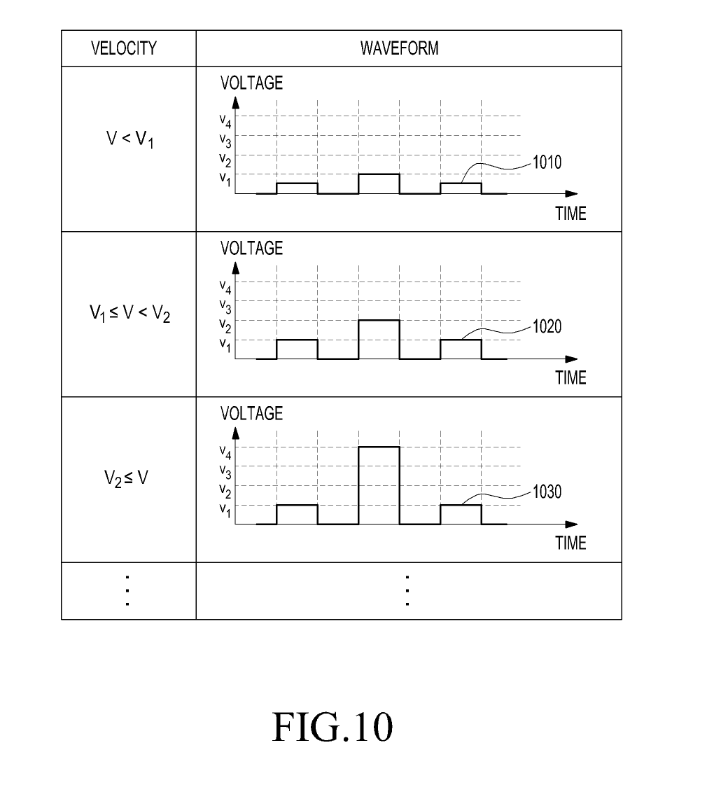

FIG. 10 is a diagram illustrating a pattern that is output with respect to a velocity of handwriting that is input onto a screen according to an embodiment of the present disclosure.

Referring to FIG. 10, the present disclosure may output at least one of a sound and a vibration with a pattern having a different waveform for a different velocity of handwriting input onto the screen 120. If the velocity of the handwriting is lower than a first velocity threshold value V1, the controller 110 outputs at least one of a sound and a vibration by using a first waveform 1010. If the velocity of the handwriting is lower than a second threshold value V2 and is higher than the first velocity threshold value V1, the controller 110 outputs at least one of a sound and a vibration by using a second waveform 1020. If the velocity of the handwriting is higher than the second velocity threshold value V2, the controller 110 outputs at least one of a sound and a vibration by using a third waveform 1030. If the velocity of the handwriting is greater than the second velocity threshold value V2, the controller 110 may output not only the third waveform 1030, but also at least one of tactile feedback, visual feedback, and audible feedback through which the user may recognize that the velocity of the handwriting is excessively high by changing an attribute of feedback. The attribute-changed feedback includes a scratch sound that may be heard when a wall or a floor is scratched or an alarm sound. The first through third waveforms 1010 through 1030 may be the same as or different from each other. For the first waveform 1010, since the measured velocity of the handwriting is lower than a reference velocity, the first waveform 1010 is output as a waveform having a voltage lower than that of a reference waveform, that is, the second waveform 1020. For the third waveform 1030, since the measured velocity of the handwriting is higher than the reference velocity, the third waveform 1030 is output as a waveform having a voltage higher than that of the reference waveform, that is, the second waveform 1020. As such, the present disclosure outputs a pattern corresponding to a waveform having a high voltage proportionally to the measured velocity. Embodiments of the present disclosure may also output a pattern corresponding to a waveform having a low voltage inversely proportional to the measured velocity.

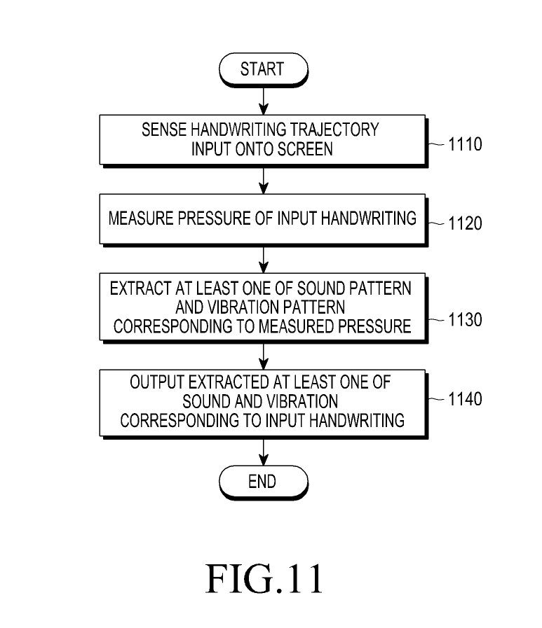

FIG. 11 is a flowchart illustrating a process of outputting feedback corresponding to a pressure of handwriting input onto the screen 120 according to another embodiment of the present disclosure.

In to FIG. 11, a description will now be made of a process of outputting feedback corresponding to a pressure of a handwriting input onto a screen according to an embodiment of the present disclosure.

Referring to FIG. 11, the controller 110 senses a handwriting trajectory input onto the screen 120 in operation 1110. The controller 110 senses the input handwriting by using a touch on the screen 120. The handwriting may include various forms of handwriting expressed by an input unit or a finger's gesture, such as a character or a picture. The controller 110 may sense at least one input inputted on a home button (not illustrated), a menu button (not illustrated), a back button (not illustrated), and the like provided on the exterior of the electronic device 100 as well as an input inputted on the screen 120.

The controller 110 measures a pressure of the handwriting input onto the screen 120 in operation 1120 and extracts at least one of a sound pattern and a vibration pattern corresponding to the measured pressure in operation 1130. The controller 110 may measure the pressure of the input handwriting per unit time. The controller 110 may measure the handwriting input onto the screen 120, measure the pressure of the sensed handwriting, and extract at least one of a sound pattern and a vibration pattern corresponding to the measured pressure. The controller 110 may also sense the handwriting input onto the screen 120 and extract a pattern corresponding to each coordinate axis along the moving direction of the sensed handwriting. The controller 110 may also extract a pattern corresponding to the velocity of the handwriting input onto the screen 120. The controller 110 may extract at least one of a sound pattern and a vibration pattern corresponding to the pressure of the handwriting or extract a pattern corresponding to a unit vector and/or component vector of each coordinate axis along the moving direction of the input handwriting. The controller 110 may extract at least one of the sound pattern and the vibration pattern corresponding to the velocity of the handwriting, and sum the extracted patterns. The controller 110 may also extract and sum a pattern corresponding to the pressure and/or velocity of the handwriting and a pattern corresponding to the moving direction of the handwriting. Embodiments of the present disclosure may extract a pattern corresponding to each of the moving direction, the velocity, and the pressure of the input handwriting. Typically, the handwriting may be performed using the moving direction, the velocity, and the pressure at the same time, and even when the moving direction, the velocity, and the pressure are simultaneously used, patterns corresponding to respective attributes are extracted and summed, such that even when the moving direction, the velocity, and the pressure are simultaneously used, the controller 110 may output at least one of sound and vibration with the summed pattern.

The controller 110 outputs the extracted at least one of the sound pattern and the vibration pattern corresponding to the input handwriting in operation 1140. The controller 110 may output at least one of the sound pattern and the vibration pattern corresponding to the pressure measured per unit time for the input handwriting. The controller 110 may also sum a pattern corresponding to the pressure measured per unit time with a pattern corresponding to the pressure of the handwriting per unit time and output a pattern corresponding to the summation result. The output strength of the extracted at least one of the sound pattern and the vibration pattern may be in proportion to or in inverse proportion to the measurement result. For example, as the measured pressure of the handwriting increases, the output strength of the pattern may increase or decrease. If the measurement result is greater than a threshold value, the output strength of at least one of the sound pattern and the vibration pattern may be greater than a strength corresponding to the threshold value. If the measurement result is less than the threshold value, the output strength of at least one of the sound pattern and the vibration pattern may be less than a strength corresponding to the threshold value. The controller 110 may output the extracted at least one of the sound pattern and the vibration pattern corresponding to the pressure of handwriting, output the extracted pattern on each coordinate axis along the moving direction of the input handwriting, or output a new pattern corresponding to the summation result of the pattern corresponding to the pressure of the handwriting with the pattern corresponding to the moving direction of the handwriting.

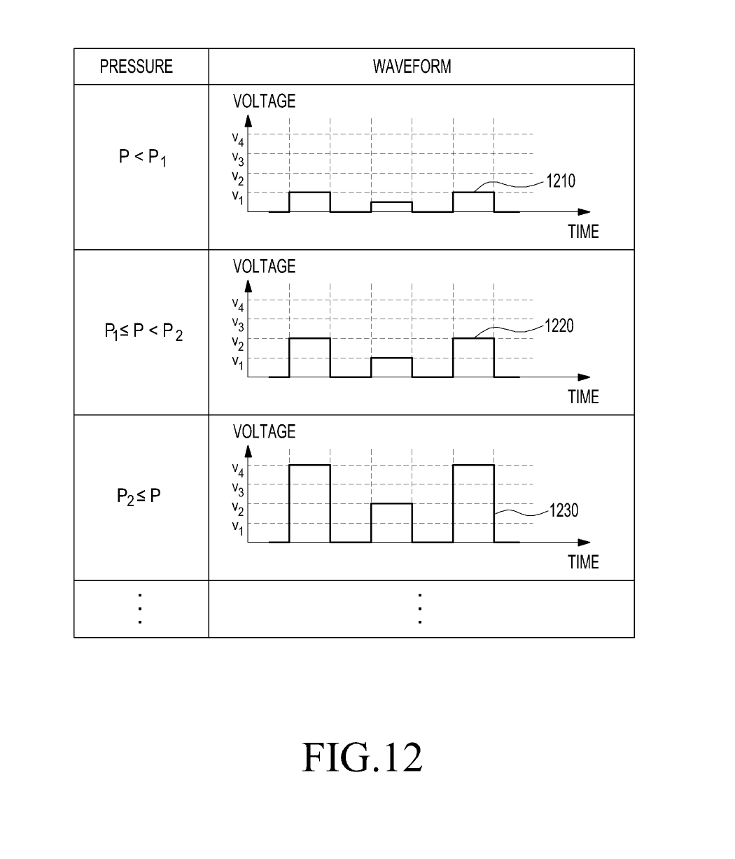

FIG. 12 is a diagram illustrating patterns output corresponding to pressures of handwriting input onto a screen according to an embodiment of the present disclosure.

Referring to FIG. 12, the present disclosure outputs at least one of a sound and a vibration with a pattern having a different waveform for a different pressure (Pascal) of handwriting input onto the screen 120. If the pressure of the handwriting is less than a first pressure threshold value P1, the controller 110 outputs at least one of sound and vibration by using a first waveform 1210. If the pressure of the handwriting is smaller than a second pressure threshold value P2 and is greater than the first pressure threshold value P1, the controller 110 outputs at least one of sound and vibration by using a second waveform 1220. If the pressure of the handwriting is greater than the second pressure threshold value P2, the controller 110 outputs at least one of sound and vibration by using a third waveform 1230. If the pressure of the handwriting is greater than the second pressure threshold value P2, the controller 110 may output not only the third waveform 1230, but also at least one of tactile feedback, visual feedback, and audible feedback through which the user may recognize that the pressure of the handwriting is excessively high by changing an attribute of feedback. The attribute-changed feedback includes an effect in which the input unit is bent or broken or paper is torn along a handwriting input direction, or an alarm sound. The first through third waveforms 1210 through 1230 may be the same as or different from each other. For the first waveform 1210, since the measured pressure of the handwriting is lower than a reference pressure, the first waveform 1210 is output as a waveform having a voltage lower than that of a reference waveform, that is, the second waveform 1220. For the third waveform 1230, since the measured pressure of the handwriting is higher than the reference pressure, the third waveform 1230 is output as a waveform having a voltage higher than that of the reference waveform, that is, the second waveform 1220. As such, embodiments of the present disclosure may output a pattern corresponding to a waveform having a high voltage proportional to the measured pressure. Embodiments of the present disclosure may also output a pattern corresponding to a waveform having a low voltage inversely proportional to the measured pressure.

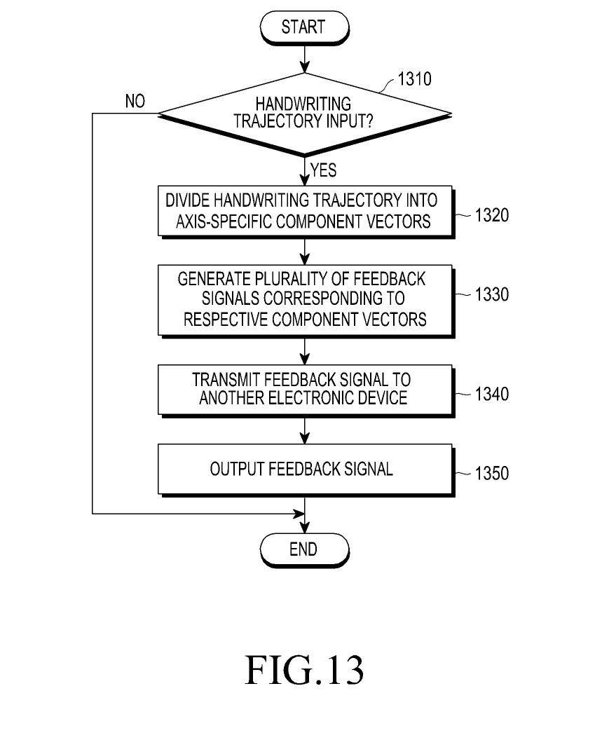

FIG. 13 is a flowchart illustrating a process of transmitting feedback corresponding to a handwriting trajectory to another device according to an embodiment of the present disclosure.

In FIG. 13, a description will be made of a process of transmitting feedback corresponding to a handwriting trajectory to another device according to an embodiment of the present disclosure.

Referring to FIG. 13, the controller 110 senses a handwriting trajectory input onto the screen 120 in operation 1310, and divides the input handwriting trajectory into axis-specific component vectors in operation 1320. The controller 110 may sense the input handwriting trajectory per unit time. The controller 110 may divide the input handwriting trajectory into axis-specific component vectors based on a length or a distance of the input handwriting trajectory per unit time. A feedback signal may be assigned for each coordinate axis in advance. The controller 110 may control at least one of an amplitude and a frequency of the assigned feedback signal based on a length or a distance of each axis-specific component vector.

The controller 110 generates a feedback signal corresponding to each component vector in operation 1330. The controller 110 may generate a plurality of feedback signals corresponding to axis-specific component vectors. The controller 110 may control the input/output unit 150 to separately output the feedback signal generated for each coordinate axis or combine the feedback signals generated for the respective coordinate axes. The controller 110 may adjust at least one of an amplitude and a frequency of the feedback signal generated for each coordinate axis to generate a feedback signal. The controller 110 may sum a pattern that is set for a unit vector of each coordinate axis along the moving direction of the handwriting input onto the screen 120 or a pattern adjusted from a component vector of each coordinate axis to generate a new pattern of at least one of a sound and a vibration. Once the moving direction of handwriting is sensed, the controller 110 may sum patterns corresponding to coordinate values in a distance along the moving direction (for example, an X-axis coordinate value, a Y-axis coordinate value, or a Z-axis coordinate value). The controller 110 may control at least one of an amplitude and a frequency of a feedback signal that is preset for each coordinate axis based on a moving distance of a handwriting trajectory. The controller 110 may generate a feedback signal through such a control. The controller 110 may separately output or sum and output patterns that are preset for coordinate axes.

The controller 110 transmits the generated feedback signal to another electronic device in operation 1340. The other electronic device may be an electronic device functionally connected with the electronic device 100 according to various embodiments of the present disclosure. The other electronic device receives a feedback signal transmitted from the electronic device 100 and outputs feedback corresponding to the received feedback signal. The other electronic device may include an input unit that may be mounted on the electronic device. The other electronic device may be an electronic device capable of communication with the electronic device 100.

The controller 110 outputs the generated feedback signal in operation 1350. The controller 110 may output the feedback signal generated corresponding to the input handwriting trajectory. The controller 110 may generate and output a feedback signal corresponding to the input handwriting trajectory on a real time basis. The feedback signal may include at least one of a vibration and a sound.

It can be seen that embodiments of the present disclosure may be implemented with hardware, software, or a combination of hardware and software. Such arbitrary software may be stored, whether or not erasable or re-recordable, in a volatile or non-volatile storage such as a ROM; a memory such as a RAM, a memory chip, a device, or an integrated circuit; and an optically or magnetically recordable and machine (for example, computer)-readable storage medium such as a Compact Disc (CD), a Digital Versatile Disk (DVD), a magnetic disk, or a magnetic tape. It can be seen that the storage included in the electronic device is an example of a machine-readable storage medium for storing a program or programs including instructions implementing various embodiments of the present disclosure. Thus, the present disclosure includes a program including codes for implementing an apparatus or method claimed in an arbitrary claim and a machine(for example, computer)-readable storage medium for storing such a program.

The electronic device may receive and store the program from a program providing device connected in a wired or wireless manner. The program providing device may include a storage for storing a program including instructions for instructing the electronic device to execute the claimed method for outputting feedback corresponding to input handwriting, information necessary for the method for outputting feedback corresponding to input handwriting, a communication unit for performing wired or wireless communication with the electronic device, and a controller for transmitting a corresponding program to the electronic device at the request of the electronic device or automatically.

According to various embodiments of the present disclosure, by providing an electronic device and method for outputting feedback corresponding to input handwriting, user convenience may be provided.

According to an embodiment of the present disclosure, feedback is output based on an attribute of input handwriting, thereby providing various feedback to users.

According to another embodiment, a handwriting trajectory is input onto a screen, the input handwriting trajectory is divided into axis-specific component vectors, a feedback signal corresponding to each component vector is generated, and the generated feedback signal is output, such that an excellent user experience may be provided.

According to another embodiment of the present disclosure, at least one of a velocity and a pressure of input handwriting is measured, and at least one of a sound pattern and a vibration pattern corresponding to the measured at least one of the velocity and pressure is extracted for output corresponding to the input handwriting, thereby providing various visual, tactile, or audible feedback to users.

Other effects that may be obtained or expected from embodiments of the present disclosure are explicitly or implicitly disclosed in the description of embodiments of the present disclosure. That is, various effects expected from embodiments of the present disclosure have been disclosed in the description of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for outputting feedback corresponding to a handwriting trajectory, the method comprising:
receiving input of the handwriting trajectory onto a screen;
dividing the handwriting trajectory into axis-specific component vectors;
generating a plurality of feedback signals corresponding to the respective component vectors; and
outputting the feedback signals corresponding to the handwriting trajectory.

2. The method of claim 1, wherein the generating of the plurality of feedback signals comprises extracting a unit feedback signal corresponding to each coordinate axis from among at least one specified unit feedback signals.

3. The method of claim 1, wherein the outputting of the feedback signals comprises separately outputting the feedback signals generated for each coordinate axis, or combining the generated feedback signals and outputting the combination result.

4. The method of claim 1, wherein the feedback signals are output after at least one of amplitudes and frequencies of the feedback signals are adjusted.

5. The method of claim 2, wherein the unit feedback signal corresponding to each coordinate axis comprises a first unit feedback signal corresponding to a first coordinate axis and a second unit feedback signal corresponding to a second coordinate axis.

6. The method of claim 5, wherein the first unit feedback signal and the second unit feedback signal include different signal patterns.

7. The method of claim 1, wherein each coordinate axis comprises a first coordinate axis and a second coordinate axis, and the plurality of feedback signals are changed in their amplitudes based on a component vector on the first coordinate axis and are changed in their frequencies based on the second coordinate axis.

8. The method of claim 1, wherein the feedback signals are generated based on a length of a component vector measured periodically.

9. The method of claim 1, wherein the feedback signals differ with at least one of a moving direction, a velocity, and a pressure of the handwriting trajectory.

10. The method of claim 1, wherein the generating of the feedback signals comprises:
extracting at least one of a sound pattern and a vibration pattern corresponding to a vector component of each coordinate axis along a moving direction of the handwriting trajectory; and
summing the extracted patterns.

11. The method of claim 1, wherein the generated feedback signals are output corresponding to the input of the handwriting trajectory on a real time basis.

12. The method of claim 10, wherein the feedback signals are output proportional to or inversely proportional to at least one of the velocity and the pressure of the handwriting trajectory.

13. The method of claim 1, further comprising transmitting the feedback signals to another electronic device that is external to the electronic device to allow the other electronic device to output the feedback signals.

14. An electronic device comprising:
a screen configured to receive an input of a handwriting trajectory;
a controller configured to divide the handwriting trajectory into axis-specific component vectors and generate a plurality of feedback signals corresponding to the respective component vectors;
a communication unit configured to transmit the feedback signals to another electronic device; and
an output unit configured to output the feedback signals corresponding to the handwriting trajectory.

15. The electronic device of claim 14, further comprising a storage configured to store a unit feedback signal specified for each coordinate axis corresponding to at least one of a moving direction, a velocity, and a pressure of the handwriting trajectory,
wherein the controller is configured to extract the unit feedback signal for the handwriting trajectory.

16. The electronic device of claim 14, wherein the controller is configured to separately output the feedback signals generated for each coordinate axis or combine the generated feedback signals and output the combination result.

17. The electronic device of claim 14, wherein the controller is configured to adjust at least one of amplitudes and frequencies of the feedback signals.

18. The electronic device of claim 14, wherein each coordinate axis comprises a first coordinate axis and a second coordinate axis, the unit feedback signal assigned to the first coordinate axis includes a first signal pattern, and the unit feedback signal assigned to the second coordinate axis includes a second signal pattern that is different from the first signal pattern.

19. The electronic device of claim 14, wherein the controller is configured to control at least one of an operation of changing amplitudes of the feedback signals based on a component vector of the first coordinate axis and an operation of changing frequencies of the feedback signals based on a component vector of the second coordinate axis.

20. The electronic device of claim 14, wherein the controller is configured to measure the handwriting trajectory every specified unit time and to generate the feedback signals based on a length of the component vector corresponding to the unit time.

21. The electronic device of claim 14, wherein the controller is configured to sense at least one of a moving direction, a velocity, and a pressure of the handwriting trajectory input onto the screen on a real time basis.

22. The electronic device of claim 14, wherein the controller is configured to map the handwriting trajectory to a coordinate space on the screen to divide the handwriting trajectory into the component vectors of the respective coordinate axes and to sum patterns corresponding to the component vectors of the respective coordinate axes.

23. An input unit comprising:
a short-range communication unit functionally connected with an electronic device to receive a feedback signal from the electronic device;
a controller configured to control the feedback signal; and
an output unit configured to output the feedback signal.

24. A method for controlling a screen by using an electronic device, the method comprising:
obtaining an input from a user through the screen;
determining at least one input attribute corresponding to the input based on at least one of a moving direction, a velocity, and a pressure of the input; and
outputting a feedback signal determined based on the at least one input attribute through an output device functionally connected with the electronic device,
wherein if the at least one input attribute is a first attribute, a first feedback signal is provided, and if the at least one input attribute is a second attribute, a second feedback signal is provided.

25. The method of claim 24, further comprising extracting a unit feedback signal corresponding to each coordinate axis from among at least one specified unit feedback signals.

26. The method of claim 24, wherein the at least one input attribute comprises a first input attribute and a second input attribute, and
the outputting of the determined feedback signal comprises separately outputting feedback signals, respectively, corresponding to the first input attribute and the second input attribute, as a plurality of signals or combining the feedback signals and outputting one signal.

27. The method of claim 24, wherein the feedback signals are output after at least one of amplitudes and frequencies of the feedback signals are adjusted based on the at least one input attributes.

28. The method of claim 25, wherein the unit feedback signal corresponding to each coordinate axis comprises a first unit feedback signal corresponding to a first coordinate axis and a second unit feedback signal corresponding to a second coordinate axis.

29. The method of claim 28, wherein the first unit feedback signal and the second unit feedback signal include different signal patterns.

30. The method of claim 25, wherein each coordinate axis comprises a first coordinate axis and a second coordinate axis, and the feedback signals are changed in their amplitudes based on a component vector on the first coordinate axis and are changed in their frequencies based on the second coordinate axis.

31. The method of claim 27, wherein the amplitudes of the feedback signals are output proportional to or inversely proportional to at least one of velocity and pressure of the input.

32. The method of claim 24, further comprising:
extracting at least one of a sound pattern and a vibration pattern corresponding to a vector component of each coordinate axis along a moving direction of the handwriting trajectory; and
summing the extracted patterns.

33. The method of claim 24, further comprising transmitting the feedback signal to another electronic device that is external to the electronic device to allow the other electronic device to output the feedback signal.
